(19) United States
(12) Patent Application Publication
(10) Pub. No.: US 2014/0212050 A1
(43) Pub. Date: Jul. 31, 2014

(54) SYSTEMS AND METHODS FOR PROCESSING AN IMAGE

(71) Applicant: QUALCOMM Incorporated, San Diego, CA (US)

(72) Inventors: Bo Zhou, San Diego, CA (US); Zhijie Deng, San Diego, CA (US); Xinping Zhang, San Diego, CA (US); Junchen Du, San Diego, CA (US); Ning Bi, San Diego, CA (US); Suhail Jalil, Poway, CA (US)

(21) Appl. No.: 13/935,798

(22) Filed: Jul. 5, 2013

Related U.S. Application Data
(60) Provisional application No. 61/758,665, filed on Jan. 30, 2013.

(51) Int. Cl. G06K 9/46

(52) U.S. Cl. CPC G06K 9/46
USPC 382/205

(57) ABSTRACT

A method for processing an image is described. Mask bits are determined for a current pixel. The mask bits indicate intensity comparisons between the current pixel and multiple neighboring pixels. The mask bits also indicate whether each of the current pixel's neighboring pixels have been processed. A next pixel is selected for processing based on the mask bits.

### RELATED APPLICATIONS

This application is related to and claims priority from U.S. Provisional Patent Application Ser. No. 61/758,665, filed Jan. 30, 2013, for “DETECTING MAXIMALLY STABLE EXTREMAL REGIONS IN AN IMAGE.”

### TECHNICAL FIELD

The present disclosure relates generally to electronic devices. More specifically, the present disclosure relates to systems and methods for processing an image.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., cameras, video camcorders, digital cameras, cellular phones, smart phones, computers, televisions, etc.) capture or utilize images. For example, a digital camera may capture a digital image.

New and/or improved features of electronic devices are often sought for. As can be observed from this discussion, systems and methods that add new and/or improved features of electronic devices may be beneficial.

### BRIEF DESCRIPTION OF THE DRAWINGS

FIG. 1 is a block diagram illustrating an electronic device for processing an image;

FIG. 1A illustrates some components within the system of FIG. 1 being implemented by a processor;

FIG. 2 is a flow diagram illustrating a method for processing an image;

FIG. 3 is a flow diagram illustrating a more detailed method for processing an image;

FIG. 4 is a flow diagram illustrating another configuration of a method for processing an image;

FIGS. 5A-5I are block diagrams illustrating steps for processing an image in which one or more extremal regions may be detected;

FIG. 6 is a block diagram illustrating a neighbor map according to the systems and methods described herein; and

FIG. 7 illustrates certain components that may be included within an electronic device/wireless device.

### SUMMARY

A method for processing an image is described. The method includes determining, for a current pixel, mask bits that indicate intensity comparisons between the current pixel and multiple neighbor pixels. The mask bits also indicate whether each of the current pixel's neighbor pixels have been processed. The method also includes selecting a next pixel for processing based on the mask bits.

The selecting may include accessing data in a lookup table using the mask bits as an index in the lookup table. The selecting may also include selecting a next pixel based on whether any of the current pixel's neighbor pixels are both unprocessed and lower intensity than the current pixel.

The mask bits may include a comparison bit and a processing bit for each neighbor pixel. The neighbor pixels may be orthogonally adjacent to the current pixel. The neighbor pixels may be diagonally adjacent to the current pixel. The neighbor pixels may be diagonally adjacent or orthogonally adjacent to the current pixel.

The method may include classifying, as part of an extremal region, the current pixel when it has no neighbor pixels that are unprocessed. The method may include classifying the current pixel as part of a contour.

The method may include pre-processing each pixel in the image by performing the intensity comparison between a pixel and each of its neighbor pixels. The image may be a frame in a video. The method may be performed for every frame in the video.

An apparatus for processing an image is also described. The apparatus includes means for determining, for a current pixel, mask bits that indicate intensity comparisons between the current pixel and multiple neighbor pixels. The mask bits also indicate whether each of the current pixel's neighbor pixels have been processed. The apparatus also includes means for selecting a next pixel for processing based on the mask bits.

An electronic device for processing an image is also described. The electronic device includes a processor, memory in electronic communication with the processor and instructions stored in memory. The instructions are executable to determine, for a current pixel, mask bits that indicate intensity comparisons between the current pixel and multiple neighbor pixels. The mask bits also indicate whether each of the current pixel's neighbor pixels have been processed. The instructions are also executable to select a next pixel for processing based on the mask bits.

A computer-program product for processing an image is also described. The computer-program product includes a non-transitory computer-readable medium having instructions thereon. The instructions include code for causing an electronic device to determine, for a current pixel, mask bits that indicate intensity comparisons between the current pixel and multiple neighbor pixels. The mask bits also indicate whether each of the current pixel's neighbor pixels have been processed. The instructions also include code for causing the electronic device to select a next pixel for processing based on the mask bits.

### DETAILED DESCRIPTION

Maximally Stable Extremal Regions (MSER) have become a commonly used region detector type because of their high repeatability and because they are complementary to many other commonly used region detectors. MSER detectors have been successfully applied to a variety of computer vision applications, including wide-baseline stereo, object recognition, image retrieval, scene classification, and so on. Therefore, it may be desirable to quickly and accurately detect MSERs.

An extremal region is a set of pixels connected by their 4-neighbors (E, S, W and N) that satisfy the property that all of their intensities are uniformly greater or less than the intensities of every pixel that surrounds the region. An extremal region is maximally stable if, for a given intensity i and a margin A, the change in the number of pixels in the region from i−Δ to i+Δ is a local minimum.

According to a known solution, MSERs may be extracted by an algorithm whose progress can be described as a physical flood-fill adapting to the landscape. For every pixel, the dominant operations are checking whether a neighboring pixel has been processed and comparing the intensity of the pixel with the intensity of neighboring pixels. Although the algorithm has already been in linear time in the number of pixels, its computational complexity is still relatively high, which makes it difficult for computer vision applications to achieve real-time performance on mobile processors. Consequently, certain compromises may be made. For example, in optical character recognition (OCR), input images may be down-sampled both spatially and temporally for the extraction of MSERs. For instance, video graphics array (VGA) at 30 frames per second (fps) input images may be down-sampled both spatially (e.g., from VGA to quarter VGA (QVGA)) and temporally (from 30 fps to 6 fps) for the extraction of MSERs. These compromises not only may reduce recognition accuracy but may also deteriorate user experience. Therefore, improving the real-time performance of extracting MSERs may also improve computer vision applications.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

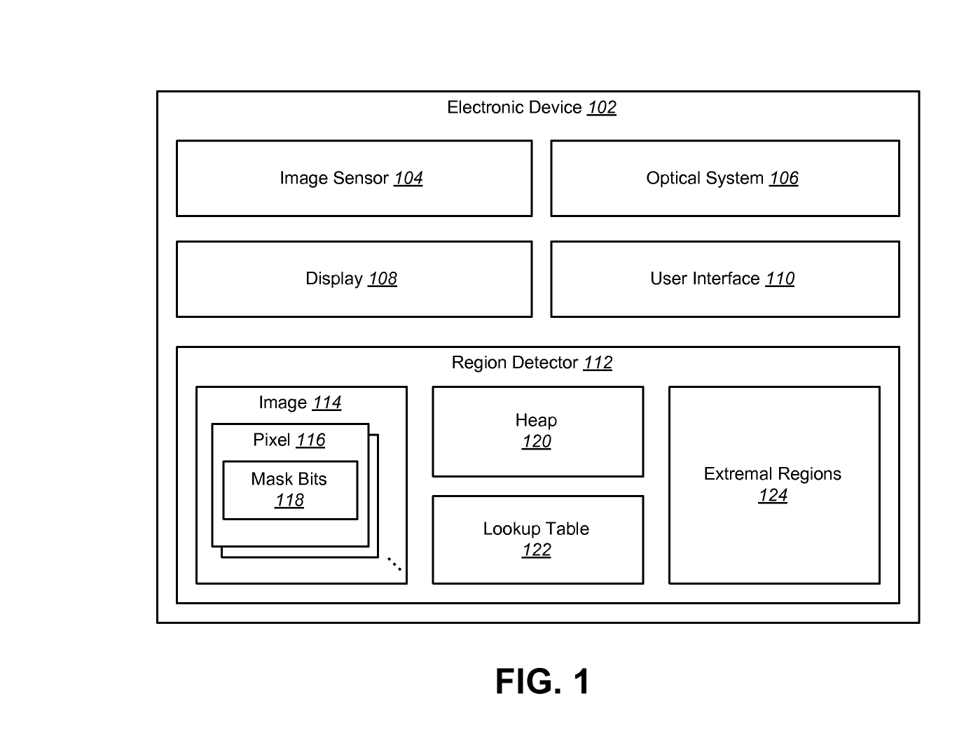

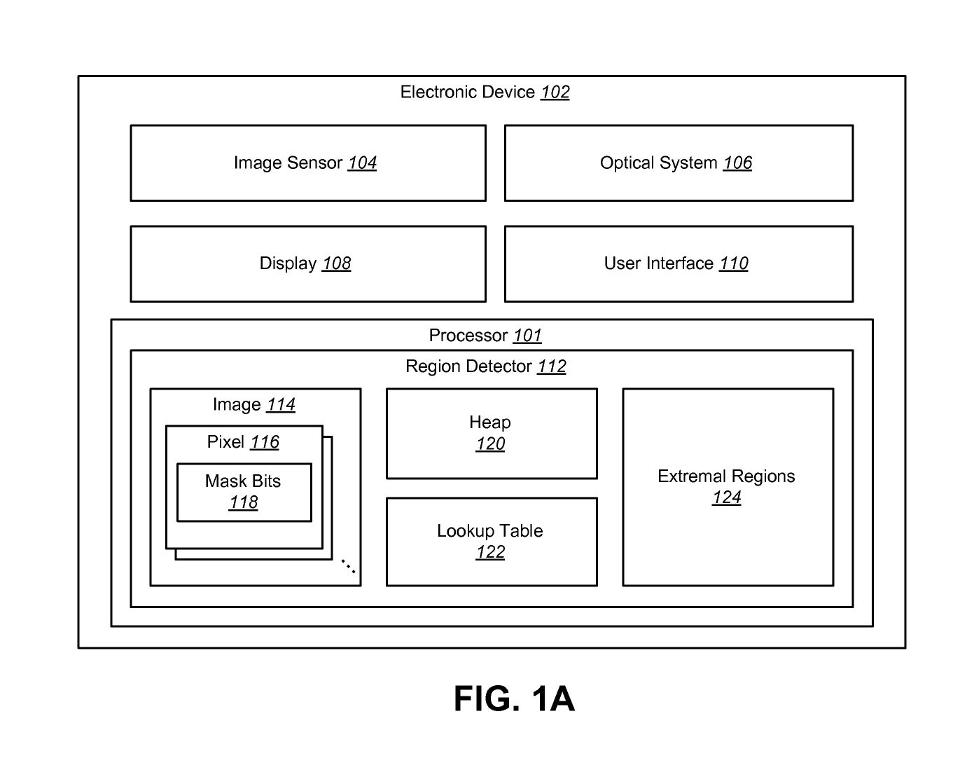

FIG. 1 is a block diagram illustrating an electronic device 102 for processing an image 114. The electronic device 102 may also be referred to as a wireless communication device, a mobile device, mobile station, subscriber station, client, client station, user equipment (UE), remote station, access terminal, mobile terminal, terminal, user terminal, subscriber unit, etc. Examples of electronic devices 102 include laptop or desktop computers, cellular phones, smart phones, wireless modems, e-readers, tablet devices, gaming systems, etc. Some of these devices may operate in accordance with one or more industry standards.

An electronic device 102, such as a smartphone or tablet computer, may include a camera. The camera may include an image sensor 104 and an optical system 106 (e.g., lenses) that focuses images 114 of objects that are located within the optical system's 106 field of view onto the image sensor 104. The electronic device 102 may also include a camera software application and a display 108. When the camera software application is running, images 114 of objects that are located within the optical system's 106 field of view may be recorded by the image sensor 104.

The images 114 that are being recorded by the image sensor 104 may be displayed on the display 108. These images 114 may be displayed in rapid succession at a relatively high frame rate so that, at any given moment in time, the objects that are located within the optical system's 106 field of view are displayed on a display 108 (e.g. a display screen, a touchscreen, etc.). Although the present systems and methods are described in terms of captured video frames, the techniques discussed herein may be used on any digital image 114. Therefore, the terms video frame and digital image may be used interchangeably herein. A user interface 110 may permit a user to interact with the electronic device 102.

It may be desirable to identify regions (e.g., maximally stable extremal regions (MSERs) 124) within an image 114 (e.g., a digital image, a captured video frame, etc.). As used herein, maximally stable extremal regions (MSERs) are referred to as “extremal regions” 124. Extremal regions 124 may be used by optical character recognition (OCR) applications to identify text in the image 114. In other words, one or more extremal regions 124 may be identified in which text is then found. A region detector 112 may identify extremal regions 124 in the image 114. In a video scenario, region detection may be performed for every frame or sporadically during captured video. Additionally, region detection may be performed for images 114 at any resolution (e.g., VGA, QVGA, etc.).

The image 114 may be a grid of pixels 116. In one configuration, a pixel 116 may have neighbor pixels 116 that are orthogonally adjacent to the pixel 116. The orthogonally adjacent neighbor pixels 116 are denoted herein by their directional relation to the pixel 116 (e.g., east (E), south (S), west (W) or north (N)). In this configuration, a corner pixel 116 may have two neighbor pixels 116, an edge pixel 116 may have three neighbor pixels 116 and an interior (e.g., non-corner, non-edge) pixel 116 may have four neighbor pixels 116. As used herein, a neighbor pixel 116 may be designated by its directional relation to a pixel 116 (e.g., neighbor E, neighbor S, etc.)

In another configuration, a pixel 116 may have neighbor pixels 116 that are diagonally adjacent to the pixel 116. The diagonally adjacent neighbor pixels 116 are denoted herein by their directional relation to the pixel 116 (e.g., north-east (NE), south-east (SE), south-west (SW) or north-west (NW)). In this configuration, a corner pixel 116 may have one neighbor pixel 116, an edge pixel 116 may have two neighbor pixels 116 and an interior (e.g., non-corner, non-edge) pixel 116 may have four neighbor pixels 116.

In yet another configuration, a pixel 116 may have neighbor pixels 116 that are either orthogonally or diagonally adjacent to the pixel 116. In this configuration, a corner pixel 116 may have three neighbor pixels 116, an edge pixel 116 may have five neighbor pixels 116 and an interior (e.g., non-corner, non-edge) pixel 116 may have eight neighbor pixels 116.

The present systems and methods may use mask bits 118 associated with every pixel 116 to select the next pixel 116 to process. The mask bits 118 may include a comparison bit and a processing bit for each neighbor pixel 116. A comparison bit may indicate an intensity comparison between a pixel 116 and a neighbor pixel 116. For example, a comparison bit associated the west neighbor (e.g., neighbor W) of a pixel 116 may indicate that the intensity of the pixel 116 is greater than the intensity of neighbor W.

The processing bits may indicate whether each of the neighbor pixels 116 of a current pixel 116 has been processed. For example, a processing bit associated with neighbor W of a pixel 116 may indicate that neighbor W has been processed, while another processing bit associated with neighbor S may indicate that neighbor S has not been processed. As used herein, the term “process” and/or “processing” may refer to the modification of one or more mask bits 118 of a neighbor pixel 116 associated with a pixel 116.

The region detector 112 may detect extremal regions 124 in the image 114. The region detector 112 may be implemented in hardware (e.g., circuitry), software or a combination of both. It should also be noted that one or more of the elements illustrated in FIG. 1 may be implemented in circuitry (e.g., integrated circuitry) in some configurations.

In one configuration, the intensity comparison between a pixel 116 and each of its neighbor pixels 116 may be performed by pre-processing each pixel 116 in the image 114. During pre-processing, the region detector 112 may set the comparison bits of each pixel 116 based on the relative intensity of the pixel 116 to its neighbor pixels 116.

The region detector 112 may select a pixel 116 as a current pixel 116 for processing. The region detector 112 may select a next pixel 116 for processing based on the mask bits 118. For example, the mask bits 118 may indicate whether any of the current pixel's 116 neighbor pixels 116 are both unprocessed and lower intensity than the current pixel 116. The region detector 112 may select an unprocessed and lower intensity neighbor pixel 116 as the next pixel 116 to process. In one configuration, the mask bits 118 may be used as an index to access data in a lookup table 122 to select the next pixel 116 to process.

As pixels 116 are processed, the current pixel 116 or neighbor pixels 116 may be queued (e.g., saved) onto a heap 120. The heap 120 may hold boundary pixels 116 of a current partial-extremal region 124. If all of the neighboring pixels 116 of the current pixel 116 have been processed, then the pixel 116 with the minimum intensity (e.g., grey-level) may be popped (e.g., retrieved) out of the heap 120 and set as the next pixel 116 for processing.

The region detector 112 may classify a current pixel 116 as part of an extremal region 124 when the current pixel 116 has no neighbor pixels 116 that are unprocessed. For example, the mask bits 118 may indicate that each of the current pixel's 116 neighbor pixels 116 are processed. Additionally or alternatively, the region detector 112 may classify a current pixel 116 as part of a contour.

As shown in FIG. 1A, the region detector 112 may be implemented by a processor 101. Alternatively, different processors may be used to implement different components (e.g., one processor may determine the mask bits 118, another processor may be used to determine the heap 120, and yet another processor may be used to determine the extremal regions 124).

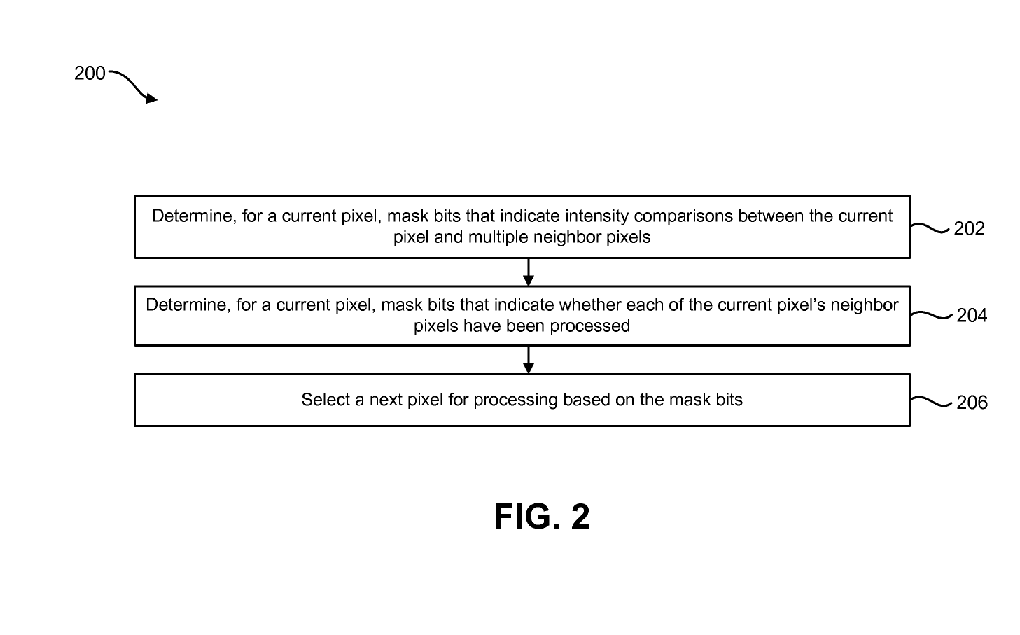

FIG. 2 is a flow diagram illustrating a method 200 for processing an image 114. The method 200 may be performed by an electronic device 102. The method 200 may be used to detect an extremal region 124 in an image 114. The electronic device 102 may determine 202, for a current pixel 116, mask bits 118 that indicate intensity comparisons between the current pixel 116 and multiple neighbor pixels 116. The intensity of a pixel 116 may correspond to the grey-level of the pixel 116. The intensity comparison between a pixel 116 and each of its neighbor pixels 116 may be performed by pre-processing each pixel 116 in the image 114. The mask bits 118 may include comparison bits associated with each neighbor pixel 116. During pre-processing, the electronic device 102 may set the comparison bits of each pixel 116 based on the relative intensity of the pixel 116 to its neighbor pixels 116.

In one configuration, the neighbor pixels 116 are orthogonally adjacent (e.g., E, S, W or N) to a pixel 116. In this configuration, the electronic device 102 may set comparison bits corresponding to neighbor E, neighbor S, neighbor W, and neighbor N for each pixel 116 during pre-processing.

In another configuration, the neighbor pixels 116 are diagonally adjacent (e.g., NE, SE, SW or NW) to a pixel 116. In this configuration, the electronic device 102 may set comparison bits corresponding to neighbor NE, neighbor SE, neighbor SW, and neighbor NW for each pixel 116 during pre-processing.

In yet another configuration, the neighbor pixels 116 are orthogonally adjacent (e.g., E, S, W or N) or diagonally adjacent (e.g., NE, SE, SW or NW) to the current pixel 116. In this configuration, the electronic device 102 may set comparison bits corresponding to neighbor NE, neighbor E, neighbor SE, neighbor S, neighbor SW, neighbor W, neighbor NW and neighbor N for each pixel 116 during pre-processing.

The electronic device 102 may determine 204, for the current pixel 116, mask bits 118 that indicate whether each of the current pixel's 116 neighbor pixels 116 have been processed. In one configuration, the mask bits 118 may include processing bits that indicate whether neighbor pixels 116 have been processed. When a current pixel 116 is processed, the processing bits of the neighbor pixels 116 are updated to indicate that the current pixel 116 was processed.

The electronic device 102 may select 206 a next pixel 116 for processing based on the mask bits 118. In one implementation, the first current pixel 116 for processing may be selected randomly, may be based on one or more locations of extremal regions 124 in previous images 114 or may be a pre-set pixel 116 (e.g., a corner pixel 116 of the image 114). The mask bits 118 of the current pixel 116 may indicate whether any of the current pixel's 116 neighbor pixels 116 are both unprocessed and lower intensity than the current pixel 116. The electronic device 102 may select 206 an unprocessed and lower intensity neighbor pixel 116 as the next pixel 116 to process.

In one configuration, the mask bits 118 may be used as an index to access data in a lookup table 122 to select 206 the next pixel 116 to process. For example, the lookup table 122 may be pre-calculated and stored in the electronic device 102. The lookup table 122 may include data (e.g., a list or an array) that corresponds to the value of the mask bits 118. Using the mask bits 118 as the index (e.g., input), the lookup table 122 may instruct the electronic device 102 on which pixel 116 to select 206 as the next pixel 116 for processing.

If the mask bits 118 indicate that a neighbor pixel 116 has been processed, then the lookup table 122 may instruct the electronic device 102 to select 206 another neighbor pixel 116 for processing. If the mask bits 118 indicate that all neighbor pixels 116 have been processed, then the current pixel 116 may be classified as part of an extremal region 124 and the next pixel 116 to be processed may be selected 206 from the heap 120.

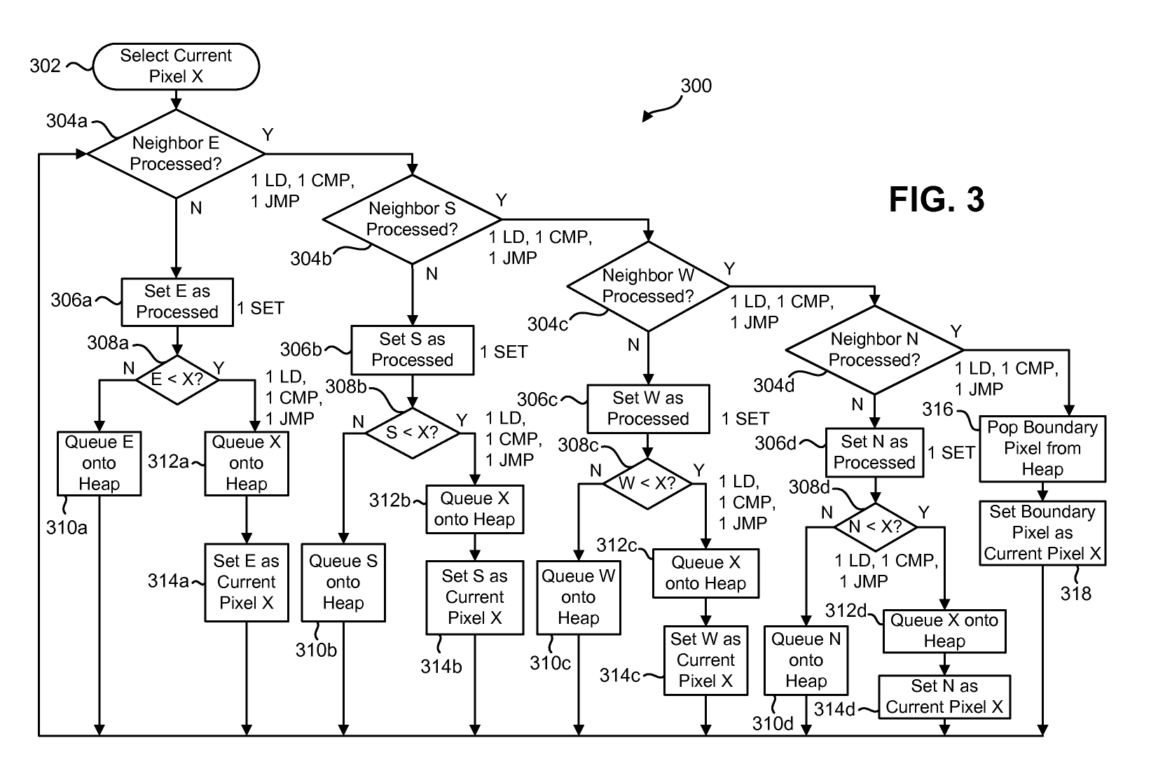

FIG. 3 is a flow diagram illustrating a more detailed method 300 for processing an image 114. The method 300 may be performed by an electronic device 102. The image 114 may be a grid of pixels 116. In the configuration illustrated in method 300 of FIG. 3, the neighbor pixels 116 are orthogonally adjacent (e.g., E, S, W or N) to the pixel 116. In the method 300, a current pixel 116 (denoted as “current pixel X”) may be selected and each neighbor pixel 116 of the current pixel 116 is determined to be processed already or not.

It should be noted that the present systems and methods are described in terms of a MSER+ algorithm, which detects extremal regions 124 satisfying the property that each pixel 116 in an extremal region 124 has an intensity that is greater than the intensity of each pixel 116 that surrounds the extremal region 124. However, the present systems and methods may also implement a MSER− algorithm, which detects extremal regions 124 in which each pixel 116 in an extremal region 124 has an intensity that is less than the intensity of each pixel 116 that surrounds the extremal region 124.

The algorithms of MSER+ and MSER− are similar, except the comparisons of pixel intensities. For example, with MSER+, the algorithm may determine whether the east neighbor pixel 116 is less than the current pixel 116 (e.g., E<X), whether the south neighbor pixel 116 is less than the current pixel 116 (e.g., S<X), whether the west neighbor pixel 116 is less than the current pixel 116 (e.g., W<X) and/or whether the north neighbor pixel 116 is less than the current pixel 116 (e.g., N<X). With MSER−, the algorithm may determine whether the east neighbor pixel 116 is greater than the current pixel 116 (e.g., E>X), whether the south neighbor pixel 116 is greater than the current pixel 116 (e.g., S>X), whether the west neighbor pixel 116 is greater than the current pixel 116 (e.g., W>X) and/or whether the north neighbor pixel 116 is greater than the current pixel 116 (e.g., N>X).

In one implementation, the electronic device 102 may select 302 a current pixel X 116. The first current pixel 116 for processing may be selected 302 randomly, may be based on one or more locations of extremal regions 124 in previous images 114 or may be a pre-set pixel 116 (e.g., a corner pixel 116 of the image 114). The electronic device 102 may determine 304a whether the east neighbor pixel 116 (e.g., neighbor E) has been processed, followed by determining 304b-d whether the south neighbor pixel 116 (e.g., neighbor S), the west neighbor pixel 116 (e.g., neighbor W) and the north neighbor pixel 116 (e.g., neighbor N) have been processed. It should be noted that the order in which neighbor pixels 116 are checked may be different than the order described in connection with FIG. 3. If the neighbor pixel 116 has been processed, the next neighbor pixel 116 in the progression (e.g., E, S, W, N) may be checked.

If the neighbor pixel 116 being checked has not been processed, the neighbor pixel 116 is set 306a-d as processed and the intensity of the neighbor pixel 116 is compared 308a-d with the intensity of the current pixel 116. If the intensity of the neighbor pixel 116 exceeds or equals the intensity of the current pixel 116, the neighbor pixel 116 is queued 310a-d onto a heap 120, but is not selected as the current pixel 116. As described above, the heap 120 may hold the boundary pixels 116 of the current partial extremal region 124. Therefore, if a pixel 116 is queued onto the heap 120, that pixel 116 may be a boundary pixel 116.

If the intensity of the neighbor pixel 116 is less than the intensity of the current pixel 116, the current pixel 116 is queued 312a-d onto the heap 120 and the neighbor pixel 116 is set 314a-d (e.g., selected) as the current pixel 116. Once all possible neighbor pixels 116 have been processed, the current pixel X 116 may be classified as part of an extremal region 124 and a boundary pixel 116 may be popped 316 from the heap 120 and set 318 as the current pixel X 116. In one configuration, the boundary pixel 116 that is popped 316 from the heap 120 may be the pixel 116 in the heap 120 with the minimum intensity.

The method 300 illustrated in FIG. 3, however, may not be very efficient. The number and type of operations are shown (in FIG. 3) next to each step in the method 300, where “LD” is a load operation, “CMP” is a compare operation, “SET” is a set operation and “JMP” is a jump operation. Each time a neighbor pixel 116 is checked 304a-d to be processed or not, the electronic device 102 performs 1 LD, 1 CMP, and 1 JMP. Additionally, each time the intensity of a neighbor pixel 116 is compared 308a-d to the intensity of the current pixel 116, the electronic device 102 performs 1 LD, 1 CMP, and 1 JMP.

Therefore, the electronic device 102 may perform the following operations for the branch of neighbor E: (1 LD, 1 CMP, 1 JMP)+(1 SET)+(1 LD, 1 CMP, 1 JMP)=(2 LD, 2 CMP, 2 JMP, 1 SET). When the branch of neighbor S is performed, the following operations may be performed: (1 LD, 1 CMP, 1 JMP)+(1 LD, 1 CMP, 1 JMP)+(1 SET)+(1 LD, 1 CMP, 1 JMP)=(3 LD, 3 CMP, 3 JMP, 1 SET). When the branch of neighbor W is performed, the following operations may be performed: (1 LD, 1 CMP, 1 JMP)+(1 LD, 1 CMP, 1 JMP)+(1 LD, 1 CMP, 1 JMP)+(1 SET)+(1 LD, 1 CMP, 1 JMP)=(4 LD, 4 CMP, 4 JMP, 1 SET). When the branch of neighbor N is performed, the following operations may be performed: (1 LD, 1 CMP, 1 JMP)+(1 LD, 1 CMP, 1 JMP)+(1 LD, 1 CMP, 1 JMP)+(1 LD, 1 CMP, 1 JMP)+(1 SET)+(1 LD, 1 CMP, 1 JMP)=(5 LD, 5 CMP, 5 JMP, 1 SET). When none of the neighbor branches are performed (all neighbors have been processed), the following operations may be performed: (1 LD, 1 CMP, 1 JMP)+(1 LD, 1 CMP, 1 JMP)+(1 LD, 1 CMP, 1 JMP)+(1 LD, 1 CMP, 1 JMP)=(4 LD, 4 CMP, 4 JMP). If each branch occurs with the same probability, the average for operations during each loop would be (3.6 LD, 3.6 CMP, 3.6 JMP, 0.8 SET).

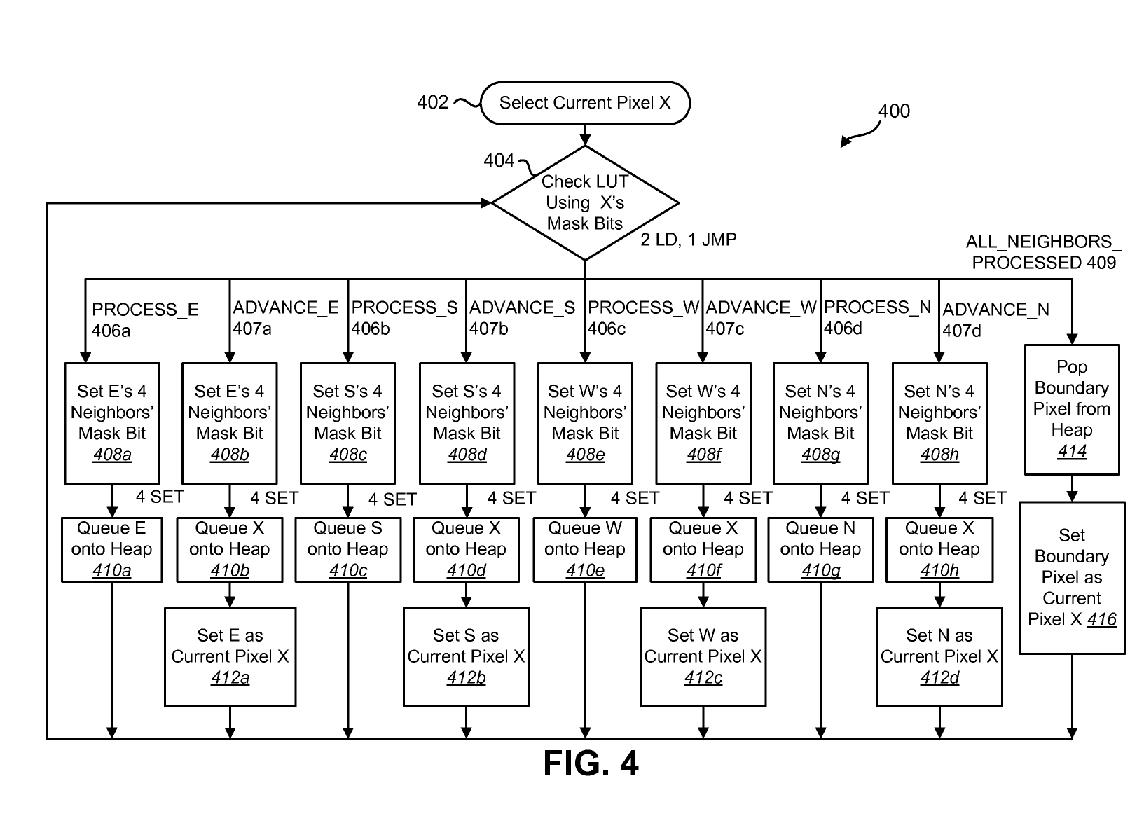

FIG. 4 is a flow diagram illustrating another configuration of a method 400 for processing an image 114. The method 400 may be performed by an electronic device 102. The method 400 illustrated in FIG. 4 may traverse pixels 116 in an image 114, queue pixels 116 onto the heap 120 based on whether a particular neighbor pixel 116 has been processed and whether the intensity of the neighbor pixel 116 exceeds the intensity of the current pixel 116. However, unlike the method 300 of FIG. 3, the method 400 in FIG. 4 may use mask bits 118 for efficiency. In other words, the method 400 of FIG. 4 traverses the image 114 in a proactive manner (e.g., the method 400 may select a corresponding branch 406, 407, 409 solely based on the mask bits 118 of the current pixel 116), instead of passively querying the status of neighbor pixels 116 and comparing the result, as in the method 300 of FIG. 3. In addition to the proactive querying method, the method 400 of FIG. 4 may use a lookup table (LUT) 122, which may contribute to the accelerated operation when implemented. In the configuration illustrated in the method 400 of FIG. 4, the neighbor pixels 116 are orthogonally adjacent (e.g., E, S, W or N) to the pixel 116.

The electronic device 102 may select 402 a current pixel X 116. The first current pixel 116 for processing may be selected 402 randomly, may be based on one or more locations of extremal regions 124 in previous images 114 or may be a pre-set pixel 116 (e.g., a corner pixel 116 of the image 114).

The computational complexity of extracting extremal regions 124 (e.g., MSERs) is more correlated with the number of pixels 116 in an image 114 than the number of extremal regions 124 detected. Specifically, for every pixel 116 in an image 114, the computational complexity heavily depends on two kinds of operations: 1) checking whether a neighbor pixel 116 has been processed, and 2) comparing the current pixel 116 intensity with the intensity of the neighbor pixels 116.

With reference to FIG. 4, the “ADVANCE” branches 407a-d may be performed when a neighbor pixel 116 has not been processed and the intensity of the neighbor pixel 116 is less than the intensity of the current pixel 116. In FIG. 4, the current pixel 116 is denoted as “current pixel X”. The “ADVANCE” branches 407a-d may mark the neighbor pixel 116 as processed, queue the current pixel 116 onto the heap 120 and set the neighbor pixel 116 as the current pixel X 116 for the next step. The “PROCESS” branches 406a-d may be performed when a neighbor pixel 116 has not been processed and the intensity of the neighbor pixel 116 is not less than the intensity of the current pixel 116. The “PROCESS” branches 406a-d may mark the neighbor pixel 116 as processed, queue the neighbor pixel 116 onto the heap 120, and leave the current pixel 116 unchanged. Therefore, the electronic device 102 may perform one of the following nine branches 406, 407, 409 (each step corresponds to a branch 406, 407, 409 in FIG. 4).

A first branch may be denoted as “PROCESS_E” 406a. If neighbor E has not been processed and the intensity of neighbor E is not less than that of the current pixel X 116, then the electronic device 102 may process neighbor E. For example, the mask bits 118 of neighbor E's four neighbor pixels 116 may be set 408a to indicate that neighbor E has been processed. Neighbor E may be queued 410a onto the heap 120.

A second branch may be denoted as “ADVANCE_E” 407a. If neighbor E has not been processed and the intensity of neighbor E is less than that of the current pixel X 116, then the electronic device 102 may process neighbor E and may set 412a neighbor E as the current pixel 116. For example, the mask bits 118 of neighbor E's four neighbor pixels 116 may be set 408b to indicate that neighbor E has been processed. The current pixel X 116 may be queued 410b onto the heap 120. Furthermore, neighbor E may be set 412a as the current pixel X 116.

A third branch may be denoted as “PROCESS_S” 406b. If neighbor E has been processed, neighbor S has not been processed, and the intensity of neighbor S is not less than that of the current pixel X 116, then the electronic device 102 may process neighbor S. For example, the mask bits 118 of neighbor S's four neighbor pixels 116 may be set 408c to indicate that neighbor S has been processed. Neighbor S may be queued 410c onto the heap 120.

A fourth branch may be denoted as “ADVANCE_S” 407b. If neighbor E has been processed, neighbor S has not been processed, and the intensity of neighbor S is less than that of the current pixel X 116, then the electronic device 102 may process neighbor S and set 412b neighbor S as current pixel. For example, the mask bits 118 of neighbor S's four neighbor pixels 116 may be set 408d to indicate that neighbor S has been processed. The current pixel X 116 may be queued 410d onto the heap 120. Furthermore, neighbor S may be set 412b as the current pixel X 116.

A fifth branch may be denoted as “PROCESS_W” 406c. If neighbors E and S have been processed, neighbor W has not been processed, and the intensity of neighbor W is not less than that of the current pixel X 116, then the electronic device 102 may process neighbor W. For example, the mask bits 118 of neighbor W's four neighbor pixels 116 may be set 408e to indicate that neighbor W has been processed. Neighbor W may be queued 410e onto the heap 120.

A sixth branch may be denoted as “ADVANCE_W” 407c. If neighbors E and S have been processed, neighbor W has not been processed, and the intensity of neighbor W is less than that of the current pixel X 116, then the electronic device 102 may process neighbor W and may set 412c neighbor W as the current pixel X 116. For example, the mask bits 118 of neighbor W's four neighbor pixels 116 may be set 408f to indicate that neighbor W has been processed. The current pixel X 116 may be queued 410f onto the heap 120. Furthermore, neighbor W may be set 412c as the current pixel X 116.

A seventh branch may be denoted as “PROCESS_N” 406d. If neighbors E, S and W have been processed, neighbor N has not been processed, and the intensity of neighbor N is not less than that of the current pixel X 116, then the electronic device 102 may process neighbor N. For example, the mask bits 118 of neighbor N's four neighbor pixels 116 may be set 408g to indicate that neighbor N has been processed. Neighbor N may be queued 410g onto the heap 120.

An eighth branch may be denoted as “ADVANCE_N” 407d. If neighbors E, S, and W have been processed, neighbor N has not been processed, and the intensity of neighbor N is less than that of the current pixel X 116, then the electronic device 102 may process neighbor N and set 412d neighbor N as the current pixel X 116. For example, the mask bits 118 of neighbor N's four neighbor pixels 116 may be set 408h to indicate that neighbor N has been processed. The current pixel X 116 may be queued 410h onto the heap 120. Furthermore, neighbor N may be set 412d as the current pixel X 116.

A ninth branch may be denoted as “ALL_NEIGHBORS_PROCESSED” 409. If all four neighbor pixels 116 have been processed, the current pixel X 116 may be classified as part of an extremal region 124. A pixel (e.g., boundary pixel) 116 may be popped 414 from the heap 120. The pixel 116 that is popped from the heap 120 may be the pixel 116 in the heap 120 with the minimum intensity. If multiple pixels 116 in the heap 120 have the same minimum intensity, then the pixel 116 that was queued 410 onto the heap most recently may be popped 414 from the heap 120. The electronic device 102 may set 416 the popped pixel 116 as the current pixel X 116.

As shown in FIG. 4, determining the branch 406, 407, 409 that may be performed is based on the mask bits 118 of the current pixel 116 (denoted as “X”). For example, the electronic device 102 may check 404 (e.g., query) a lookup table (LUT) 122 using the mask bits 118 of the current pixel X 116 as the index of the LUT 122. In the configuration illustrated in FIG. 4, there are a total of 256 combinations of the eight mask bits 118. Each entry of the lookup table 122 may be used to determine the branch 406, 407, 409 that may be performed.

Using mask bits 118 allows an electronic device 102 to avoid passively querying the status of neighbor pixels 116. Furthermore, the electronic device 102 may efficiently implement the above two kinds of operations (e.g., checking whether a neighbor pixel 116 has been processed and comparing the current pixel intensity with the intensity of neighbor pixels 116) in a proactive manner. For the configuration illustrated in FIG. 4, eight mask bits 118 (e.g., one mask byte) may be assigned for each pixel 116 as illustrated in Listing (1).

Listing (1)

typedef union {

struct {

UWord8 bNbCmpE : 1;
UWord8 bNbCmpS : 1;
UWord8 bNbCmpW : 1;
UWord8 bNbCmpN : 1;
UWord8 bNbProcE : 1;
UWord8 bNbProcS : 1;
UWord8 bNbProcW : 1;
UWord8 bNbProcN : 1;

} sMaskBit;
UWord8 nMaskByte;

} uMask;

In Listing (1), the four bits of bNbCmpE, bNbCmpS, bNbCmpW and bNbCmpN may be comparison bits that indicate the (pre-processing) comparison results of the intensity of a pixel 116 with that of its four neighbor pixels 116. For MSER+, bNbCmpY=1 (where Y=E, S, W or N) if and only if the intensity of the current pixel 116 is greater than that of its neighbor Y. For example, if the intensity of the current pixel 116 is greater than Neighbor E, then bNbCmpE=1. However, if the intensity of the current pixel 116 is not greater than Neighbor E, then bNbCmpE=0

For MSER−, bNbCmpY=1 (where Y=E, S, W or N) if and only if the intensity of the current pixel 116 is less than that of its neighbor Y. For example, if the intensity of the current pixel 116 is less than Neighbor E, then bNbCmpE=1. However, if the intensity of the current pixel 116 is not less than Neighbor E, then bNbCmpE=0.

These four comparison bits (e.g., bNbCmpE, bNbCmpS, bNbCmpW and bNbCmpN) may be set for every pixel 116 by a pre-processing function. In one configuration, the pre-processing function may be implemented efficiently on ARM processors (ARMs) (with vectorized/single instruction, multiple data (SIMD) instructions, for instance). In one implementation, the pre-processing function may set the comparison bits on all pixels 116 in an image 114 before the method 400 of claim 4 begins.

In Listing (1), the four bits of bNbProcE, bNbProcS, bNbProcW and bNbProcN may be referred to as “processing bits” that indicate whether one or more neighbor pixels 116 of a pixel 116 have been processed. In one configuration, bNbProcY=1 (where Y=E, S, W or N) if and only if the neighbor Y has been processed. The processing bits may be initialized to be 0. If a pixel 116 does not have a neighbor (e.g., if the pixel 116 is a corner pixel or an edge pixel), then bNbProcY corresponding to a non-existing neighbor pixel 116 may be set to 1. After a current pixel 116 has been processed, each neighbor pixel 116 of the current pixel 116 may be informed that the current pixel 116 has been processed by setting their corresponding mask bits 118 as illustrated in Table (1). For example, if a current pixel 116 is processed, the neighbor E may set bNbProcW to 1 because the current pixel 116 is to the west of neighbor E.

TABLE 1

| Neighbor Pixel | Mask Bit |
|---|---|
| neighbor E | bNbProcW = 1 |
| neighbor S | bNbProcN = 1 |
| neighbor W | bNbProcE = 1 |
| neighbor N | bNbProcS = 1 |

In one configuration, if a pixel 116 does not have a neighbor (e.g., if the pixel 116 is a corner-pixel or an edge-pixel), then the comparison bits (e.g., bNbCmpY) for a corresponding non-existing neighbor pixel 116 may be set to 0 (during pre-processing, for instance). In another configuration, the comparison bits (e.g., bNbCmpY) can be either 0 or 1 for a corner-pixel or an edge-pixel, as long as the processing bits (e.g., bNbProcY) corresponding to a non-existing neighbor pixel 116 is set to 1.

An example of a lookup table (LUT) 122 in accordance with the mask bits 118 illustrated in Listing (1) is provided in Table (2). For the sake of clarity, the mask bits 118 (e.g., comparison bits and processing bits) have been abbreviated in Table (2). For example, bNbProcN is denoted as “PN”, bNbProcW is denoted as “PW”, bNbProcS is denoted as “PS”, bNbProcE is denoted as “PE”, bNbCmpN is denoted as “CN”, bNbCmpW is denoted as “CW”, bNbCmpS is denoted as “CS” and bNbCmpE is denoted as “CE”. The values of the mask bits 118 are indicated, where “*” represents either a value of 0 or 1. An operation corresponding to one of the nine branches 406, 407, 409 described above is associated with various combinations of mask bit 118 values. Therefore, the mask bits 118 are an index in the LUT 122 that indicate a certain operation to be performed. The numbers of combinations of mask bit 118 values that are associated with an operation are also listed in Table (2).

TABLE 2

| | | | | | | | | Com- | |
|---|---|---|---|---|---|---|---|---|---|
| | | | | | | | | bina- | |
| PN | PW | PS | PE | CN | CW | CS | CE | tions | Operation |
| * | * | * | 0 | * | * | * | 0 | 64 | PROCESS_E |
| * | * | * | 0 | * | * | * | 1 | 64 | ADVANCE_E |
| * | * | 0 | 1 | * | * | 0 | * | 32 | PROCESS_S |
| * | * | 0 | 1 | * | * | 1 | * | 32 | ADVANCE_S |
| * | 0 | 1 | 1 | * | 0 | * | * | 16 | PROCESS_W |
| * | 0 | 1 | 1 | * | 1 | * | * | 16 | ADVANCE_W |
| 0 | 1 | 1 | 1 | 0 | * | * | * | 8 | PROCESS_N |
| 0 | 1 | 1 | 1 | 1 | * | * | * | 8 | ADVANCE_N |
| 1 | 1 | 1 | 1 | * | * | * | * | 16 | ALL_NEIGHBORS_{—} |
| | | | | | | | | | PROCESSED |

Concurrently checking the mask bits 118 of a pixel 116 may allow the electronic device 102 to avoid a situation where each individual neighbor pixel 116 is checked until an unprocessed neighbor pixel 116 is found. Furthermore, the next pixel 116 to be processed may be determined immediately. This results in more efficient extremal region 124 detection. Specifically, each table lookup may use 2 LD and 1 JMP operations. Additionally, up to 4 SET operations may be performed by an electronic device 102 every time the mask bits 118 of the neighbor pixels 116 are set.

Therefore, each of the first eight branches 406a-d, 407a-d in FIG. 4 (e.g., PROCESS_E 406a, ADVANCE_E 407a, PROCESS_S 406b, ADVANCE_S 407b, PROCESS_W 406c, ADVANCE_W 407c, PROCESS_N 406d and ADVANCE_N 407d) may perform the following operations: (2 LD, 1 JMP)+(4 SET)=(2 LD, 1 JMP, 4 SET). The last branch (e.g., ALL_NEIGHBORS_PROCESSED 409) may perform (2 LD, 1 JMP). If each branch 406a-i is equally possible, the average of every branch 406, 407, 409 may be (2 LD, 1 JMP, 3.56 SET). Since set operations are usually less computationally intensive than other operations, the method 400 of FIG. 4 may be faster and more efficient than the method 300 of FIG. 3.

The image 114 may be a grid of pixels of any size or dimension. For example, the image 114 may be a 3×3, a 3×4, a 4×4, etc. grid of pixels. If the current pixel 116 is pixel(1) and the ADVANCE_E 407a branch is being performed, then pixel(2) is processed. As used herein, “process,” “processed,” and/or “processing” a pixel 116 refers to modifying (e.g., setting) the bNbProc bits (e.g., bNbProcE, bNbProcS, bNbProcW and bNbProcN) of the neighbor pixels 116 of the pixel 116. The bNbProc bits of the neighbor pixels 116 may be modified when one of the branches 406, 407, 409 of method 400 of FIG. 4 is performed for a current pixel 116. In this example, pixel(2) is processed by setting 408b the bNbProc bits of the neighbor pixels 116 to 1. Therefore, the bNbProcW bit of pixel(3) is set 408b to 1 because pixel(2) is the west neighbor of pixel(3). The bNbProcE bit of pixel(1) is set 408b to 1 because pixel(2) is the east neighbor of pixel(1). Furthermore, the bNbProcN bit of pixel(6) is set 408b to 1 because pixel(2) is the north neighbor of pixel(6).

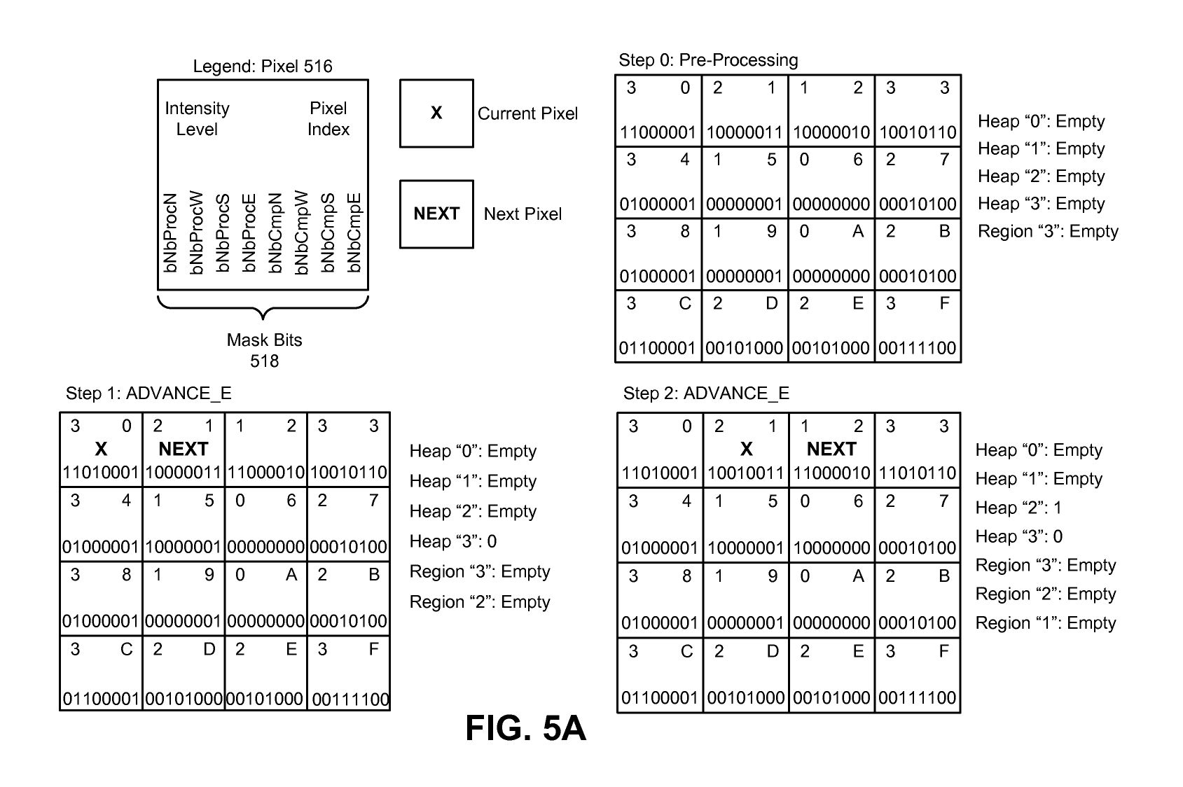

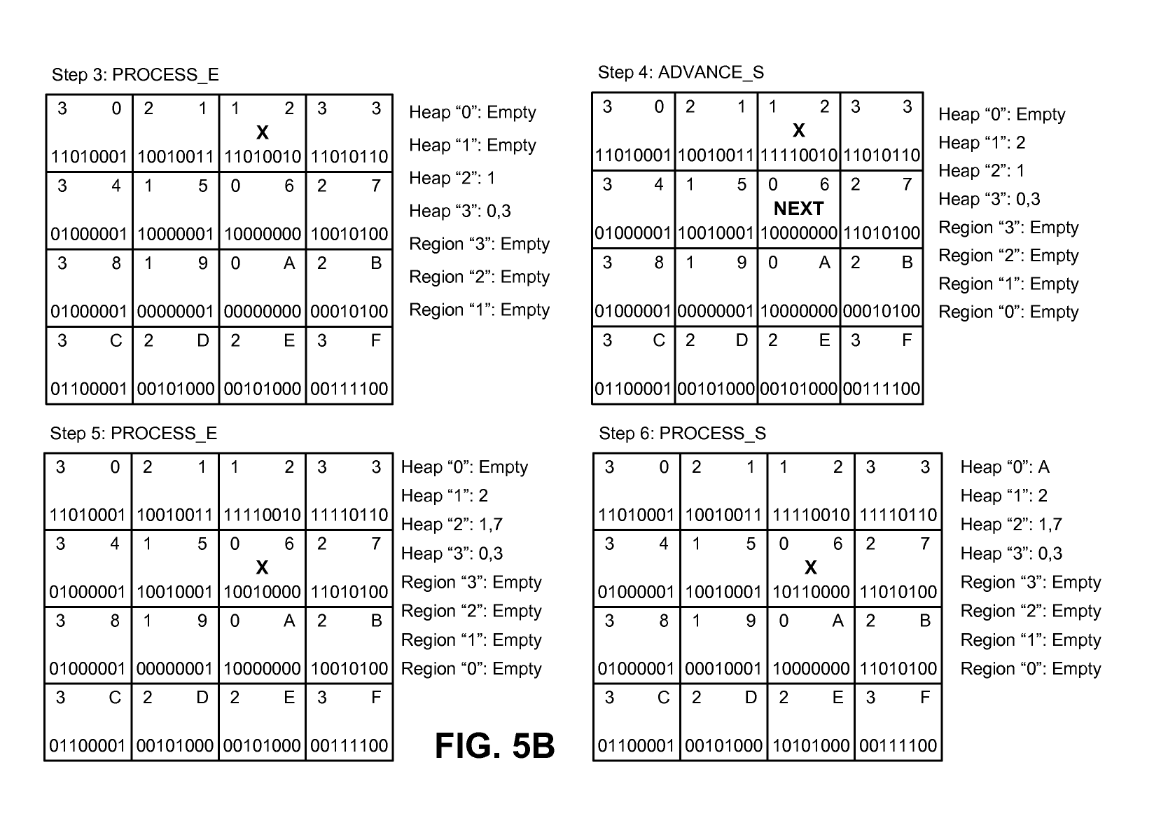

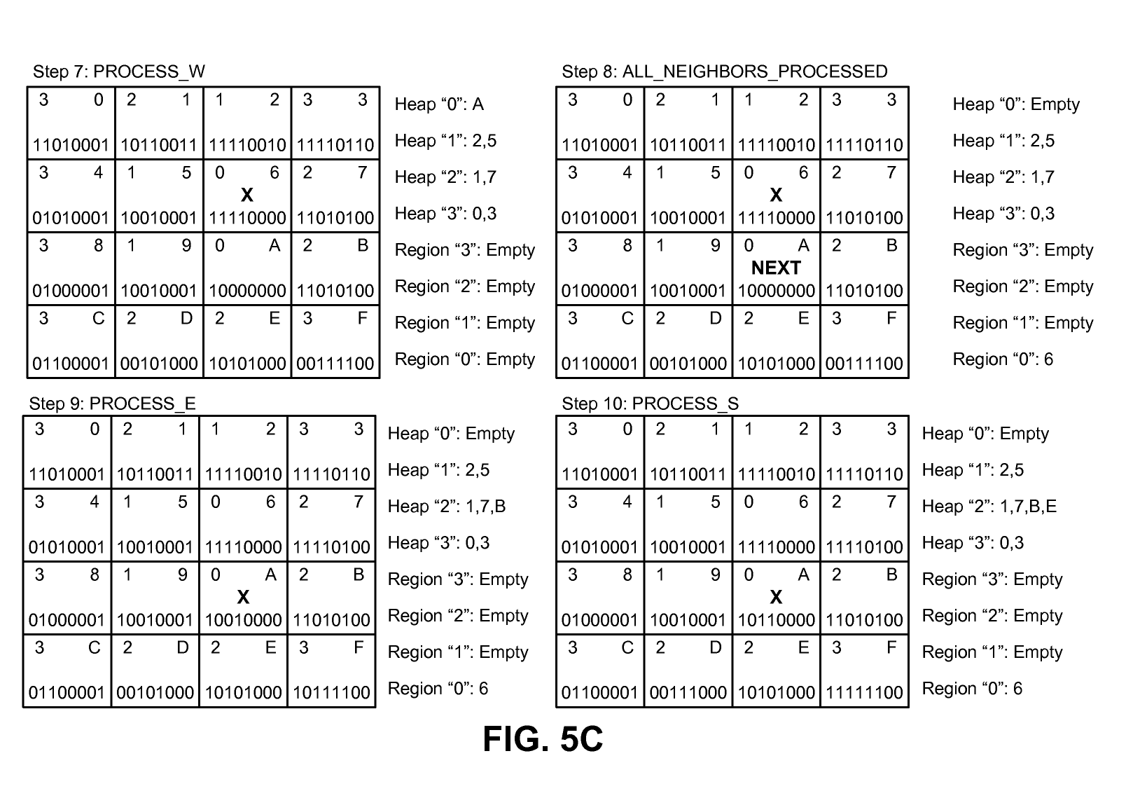

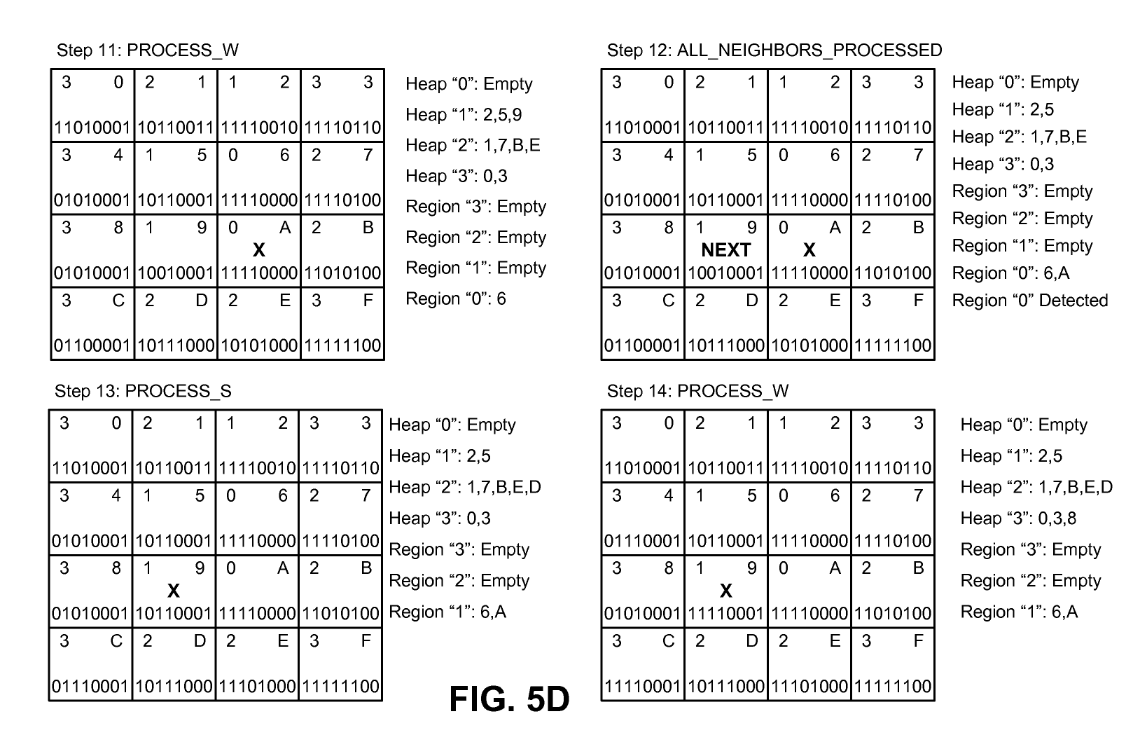

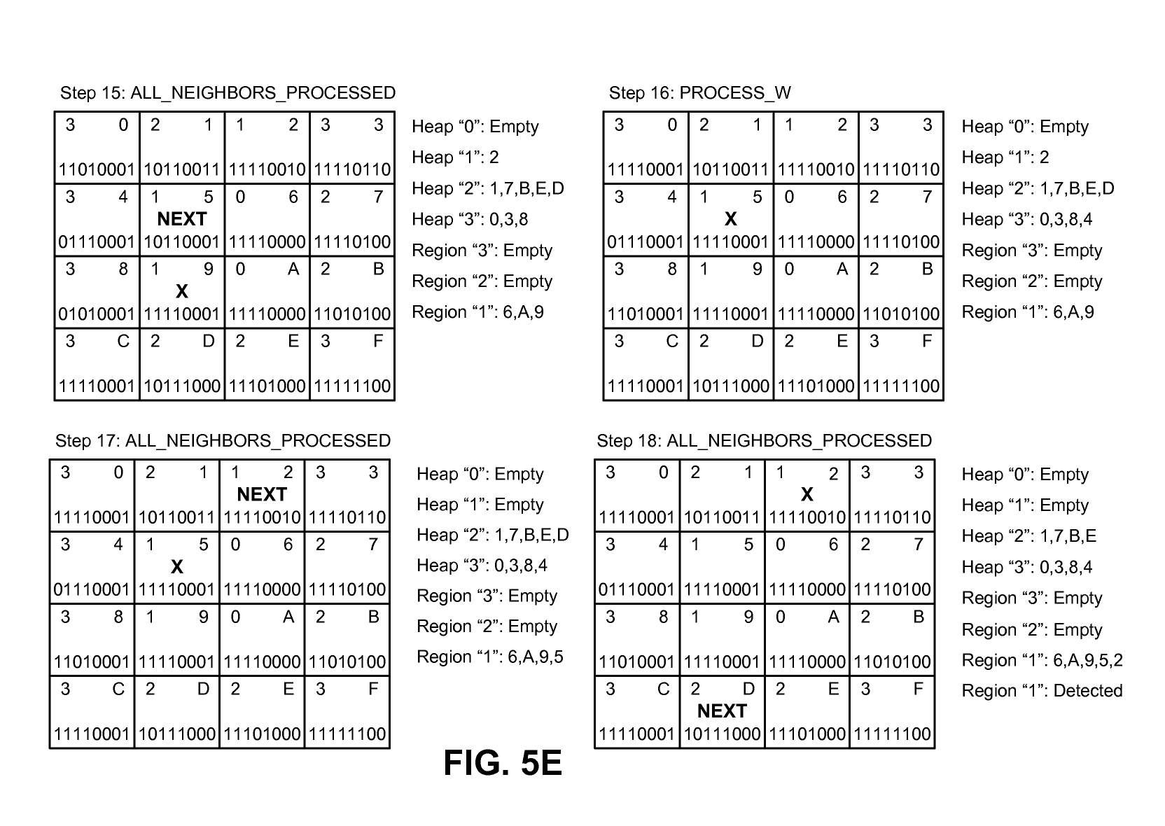

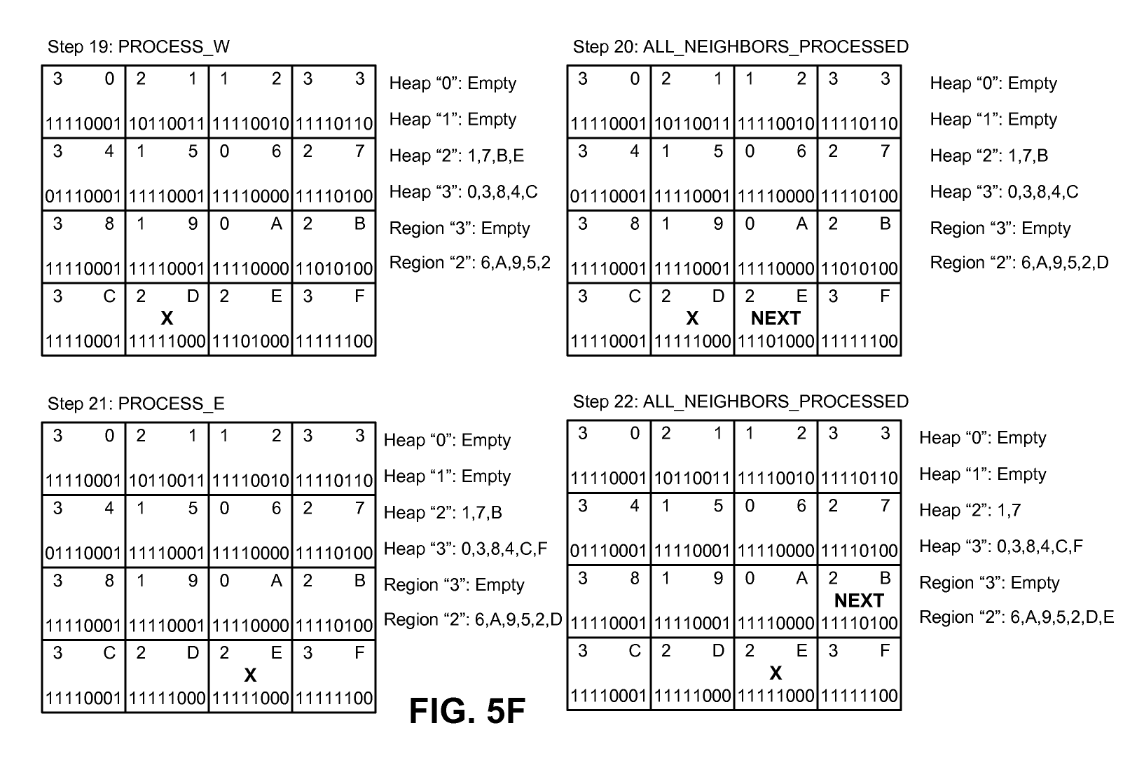

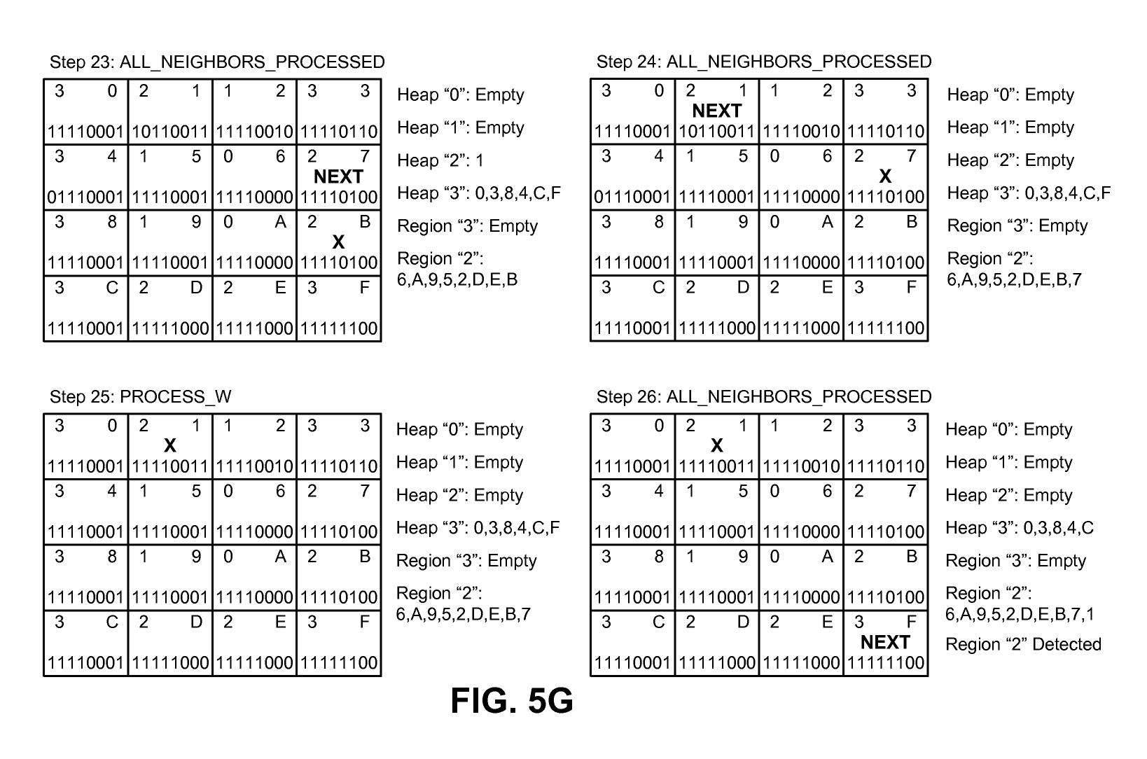

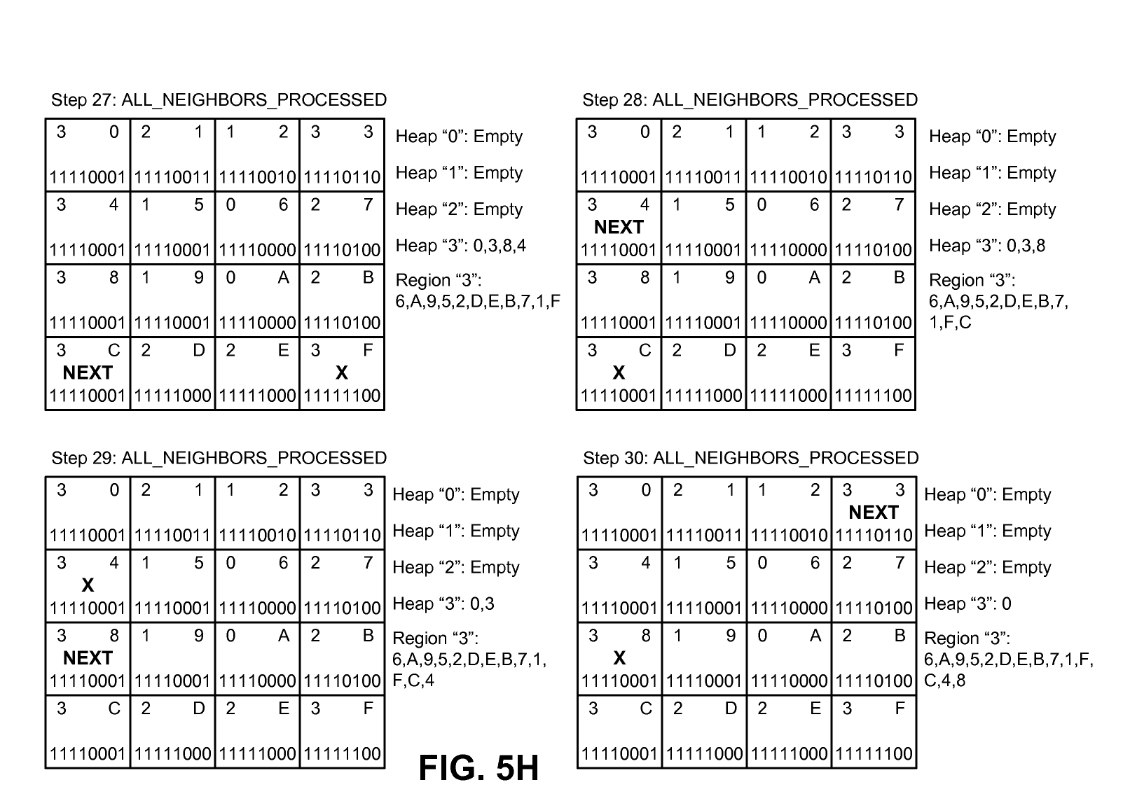

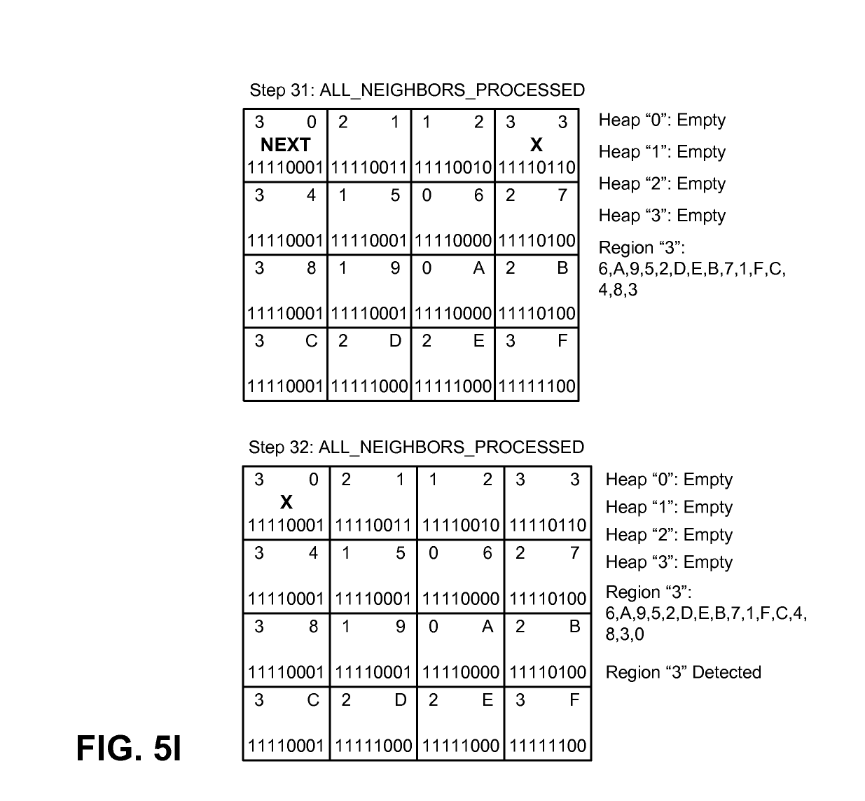

Pixel(1) may be queued 410b onto the heap 120. Pixel(2) may be set 412a as the current pixel 116. The method 400 may proceed by checking 404 the lookup table 122 using the mask bits 118 of pixel(2) to determine which branch 406, 407, 409 may be performed for pixel(2). A more detailed example of implementing method 400 is described below in connection with FIGS. 5A-5I. As used herein, the term “set a bit” means making the value of a bit “1”. By contrast, the term “clear a bit” means making the value of a bit “0”.

FIGS. 5A-5I are block diagrams illustrating steps for processing an image 114 in which one or more extremal regions 124 may be detected. Specifically, FIGS. 5A-5I illustrate how one or more extremal regions 124 may be detected using the method 400 illustrated in FIG. 4. As described by the legend in the upper left corner of FIG. 5A, the intensity (e.g., pixel intensity or grey-level) is given in the upper left corner of each pixel 516. The pixel index (e.g., pixel number) is given in the upper right corner of each pixel 516. A specific pixel 516 is indicated by its pixel index (e.g., a pixel 516 with a pixel index of 0 is denoted as “pixel(0)”). The mask bits 518 are given in the eight bits along the bottom of each pixel 516. Although the image 114 is illustrated as a 4 pixel×4 pixel image 114, the present systems and methods may be used with images 114 of any size or shape.

The example illustrated in FIGS. 5A-5I demonstrates 33 steps (e.g., steps 0-32) of the method 400 illustrated in FIG. 4. The branch from FIG. 4 that is being performed is listed above the pixel map, e.g., “Step 1: ADVANCE_E”. Furthermore, the current pixel 516 is indicated by the letter “X” and the next pixel 516 (e.g., next current pixel 516) is indicated by “NEXT”.

The heap status and region status are listed to the right of each pixel map. A heap 120 may be used to store boundary pixels 516 of a current partial extremal region 124. A pixel 516 that is included in a heap 120 may have an intensity up to a certain threshold. In one configuration, there may be multiple heaps 120 corresponding to multiple ranges of pixel intensity. For example, heap “0” may include pixels 516 that have an intensity up to 0, heap “1” may include pixels 516 that have an intensity up to “1”, etc. Therefore, the heap status listed to the right of each pixel map indicates which pixels 516 are currently in a heap 120.

The region status listed on the right of each pixel map indicates which pixels 516 have been determined to belong to a particular extremal region 124. As used herein, region “0” refers to an extremal region 124 of pixels 516 with intensity no greater than 0. Furthermore, region “1” refers to an extremal region 124 of pixels 516 with intensity no greater than 1, and so forth. In this example, there are four extremal regions 124 (e.g., regions 0-3) corresponding to the different intensities of the pixels 516.

During a pre-processing stage (Step 0 (not shown in FIG. 4)), an electronic device 102 may set the comparison bits (e.g., bNbCmpE, bNbCmpS, bNbCmpW and bNbCmpN) in the mask bits 518 of each pixel 516. Because the intensity of the pixels 516 does not change, the comparison bits may not change after the pre-processing stage. In pre-processing, the corresponding processing bits (e.g., bNbProc bits) of image 114 boundary pixels 516 are set to 1 if they do not have a neighbor on certain directions. As a result, the MSER detection of method 400 will not attempt to process those non-existing pixels. For example, the bNbProcW and bNbProcN bits of pixel(0) are set to 1 because pixel(0) does not have a west or north neighbor.

Following pre-processing, an electronic device 102 may traverse the image 114 using the mask bits 518 of each pixel 516. The electronic device 102 may select starting pixel 516 (e.g., the first current pixel 516). In one implementation, a starting pixel 516 may be chosen randomly. In another implementation, the starting pixel 516 may be selected based on one or more locations of extremal regions 124 in previous images 114. In yet another implementation, the starting pixel 516 may be a corner pixel 516 (e.g., pixel(0)). In this example, the starting pixel 516 is pixel(0).

In step 1, the mask bits 518 of pixel(0) (the current pixel 516) indicate that pixel(1) (e.g., the neighbor E of pixel(0)) has not been processed and the intensity of pixel(1) is less than pixel(0). In one configuration, mask bits 518 may be used as the index of a lookup table 122 to determine which operation to perform, as illustrated in Table (2). Therefore, the “ADVANCE_E” branch from FIG. 4 is performed for pixel(0) based on a lookup table 122 using the mask bits 518 of pixel (0) as the index of the lookup table 122. The mask bits 518 of the neighbor pixels 516 of pixel(1) are updated (e.g., set) to reflect that pixel(1) has been processed. Therefore, bNbProcE of pixel(0), bNbProcW of pixel(2) and bNbProcN of pixel(5) are set to 1. Pixel(0) is queued on heap “3”, which is used for boundary pixels 516 of extremal regions 124 with an intensity up to 3. Pixel(1) is then set as the next pixel 516 (e.g., the next current pixel 516).

In step 2, the mask bits 518 of pixel(1) indicate that pixel(2) (the neighbor E of pixel(1)) has not been processed and the intensity of pixel(2) is less than pixel(1). Therefore, “ADVANCE_E” is performed for pixel(1). The mask bits 518 of the neighbor pixels 516 of pixel(2) are set to reflect that pixel(2) has been processed. Therefore, bNbProcE of pixel(1), bNbProcW of pixel(3) and bNbProcN of pixel(6) are set to 1. Pixel(1) is queued on heap “2”, which is used for boundary pixels 516 of extremal regions 124 with an intensity up to 2. Pixel(2) is then set as the current pixel 516.

In step 3, the mask bits 518 of pixel(2) indicate that pixel(3) (the neighbor E of pixel(2)) has not been processed, but the intensity of pixel(3) is not less than pixel(2). Therefore, “PROCESS_E” is performed for pixel(2). The mask bits 518 of the neighbor pixels 516 of pixel(3) are set to reflect that pixel(3) has been processed. Therefore, bNbProcE of pixel(2) and bNbProcN of pixel(7) are set to 1. Pixel(3) is queued on heap “3”. However, pixel(2) remains as the current pixel 516.

In step 4, the mask bits 518 of pixel(2) now indicate that pixel(3) (e.g., the neighbor E of pixel(2)) has been processed, pixel(6) (e.g., neighbor S) has not been processed and the intensity of pixel(6) is less than pixel(2). Therefore, “ADVANCE_S” is performed for pixel(2). The mask bits 518 of the neighbor pixels 516 of pixel(6) are set to reflect that pixel(6) has been processed. Therefore, bNbProcE of pixel(5), bNbProcS of pixel(2), bNbProcW of pixel(7) and bNbProcN of pixel(A) are set to 1. Pixel(2) is queued on heap “1”. Pixel(6) is set as the current pixel 516.

In step 5, the mask bits 518 of pixel(6) indicate that pixel(7) (e.g., neighbor E) has not been processed, but the intensity of pixel(7) is not less than pixel(6). Therefore, “PROCESS_E” is performed for pixel(6). This may be accomplished as described above in step 3, with pixel(6) remaining as the current pixel 516.

In step 6, the mask bits 518 of pixel(6) now indicate that pixel(7) (e.g., neighbor E) has been processed, pixel(A) (e.g., neighbor S) has not been processed, but the intensity of pixel(A) is not less than pixel(6). Therefore, “PROCESS_S” is performed for pixel(A). The mask bits 518 of the neighbor pixels 516 of pixel(A) are set to reflect that pixel(A) has been processed. Therefore, bNbProcE of pixel(9), bNbProcS of pixel(6), bNbProcW of pixel(B) and bNbProcN of pixel(E) are set to 1. Pixel(A) is queued on heap “0”. However, pixel(6) remains as the current pixel 516.

In step 7, the mask bits 518 of pixel(6) now indicate that pixel(7) (e.g., neighbor E) and pixel(A) (e.g., neighbor S) have been processed, pixel(5) (e.g., neighbor W) has not been processed, but the intensity of pixel(5) is not less than pixel(6). Therefore, “PROCESS_W” is performed for pixel(5). The mask bits 518 of the neighbor pixels 516 of pixel(5) are set to reflect that pixel(5) has been processed. Therefore, bNbProcE of pixel(4), bNbProcS of pixel(1), bNbProcW of pixel(6) and bNbProcN of pixel(9) are set to 1. Pixel(5) is queued on heap “1”. However, pixel(6) remains as the current pixel 516.

In step 8, the mask bits 518 of pixel(6) now indicate that all neighbor pixels 516 have been processed. Therefore, “ALL_NEIGHB ORS_PROCESSED” is performed. Pixel(6) is identified as part of region “0”. The pixel 516 with the minimum intensity may be popped from a heap 120 and set as the current pixel 516. If there are multiple pixels 516 in the same heap 120, then the pixel 516 that is most recently queued onto the heap 120 may popped from the heap 120. In this case, pixel(A) is popped from heap “0” and set as the current pixel 516.

In steps 9-11, each of pixel(A)'s unprocessed neighbors (pixel(B), pixel(E) and pixel(9)) are processed, but since none of its neighbor's intensity is less than 0 (pixel(A)'s intensity), “ALL_NEIGHBORS_PROCESSED” is performed in step 12. Pixel(A) is identified as also being part of region “0”. At this point, region “0” is fully defined. In one configuration, the region is detected when the heap 120 of a corresponding intensity level becomes empty. Pixel(6) and pixel(A) are added to region “1”. Pixel(9) is popped out of heap “1” and set as the current pixel 516 because pixel(9) has a minimum intensity (of 1) and was the most recent pixel 516 to be queued onto heap “1”.

In steps 13-14, pixel(9)'s remaining unprocessed neighbors (pixel(D) and pixel(8)) are processed. Because none of pixel(9)'s unprocessed neighbors are lower in intensity than pixel(9)'s intensity, “ALL_NEIGHBORS_PROCESSED” is performed for pixel(9) in step 15, which identifies pixel(9) as also being part of region “1”. Pixel(5) is popped out of heap “1” and set as the current pixel 516 because pixel(5) has a minimum intensity (of 1) and was the most recent pixel 516 to be queued onto heap “1”.

In step 16, the mask bits 518 of pixel(5) indicate that pixel(3) (e.g., neighbor W) has not been processed. Therefore, “PROCESS_W” is performed for pixel(5), where pixel(5) remains as the current pixel 516.

In step 17, the mask bits 518 of pixel(5) now indicate that all neighbor pixels 516 have been processed. Therefore, “ALL_NEIGHBORS_PROCESSED” is performed for pixel(5). Pixel(5) is identified as also being part of region “1”. Pixel(2) is popped out of heap “1” and set as the current pixel 516 because pixel(2) has the minimum intensity (of 1) of the pixels 516 in a heap 120.

In step 18, the mask bits 518 of pixel(2) indicate that all neighbor pixels 516 have been processed. Therefore, “ALL_NEIGHBORS_PROCESSED” is performed for pixel(2). Pixel(2) is identified as also being part of region “1”. At this point, region “1” is fully defined. Pixels(6), (A), (9), (5) and (2) are added to region “2”. Pixel(D) is popped out of heap “2” and set as the current pixel 516 because pixel(D) has a minimum intensity (of 1) and was the most recent pixel 516 to be queued onto heap “2”. Similar procedures may be performed for regions “2” (steps 19-26) and “3” (steps 27-32).

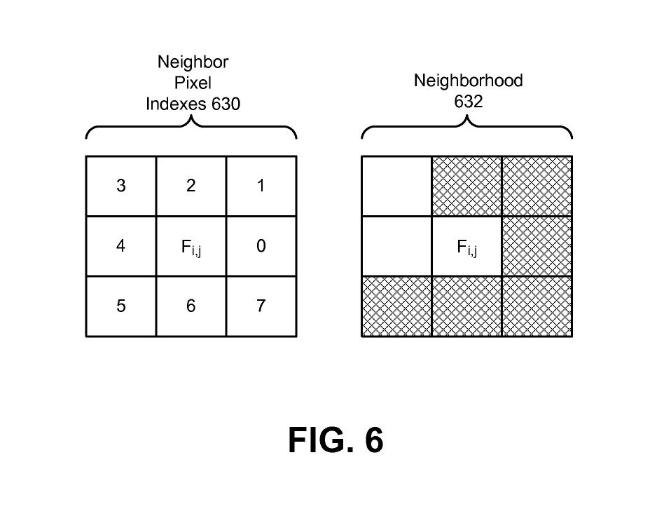

FIG. 6 is a block diagram illustrating a neighbor map according to the systems and methods described herein. To accelerate border-following (e.g., determining contour), a neighbor map using mask bits 118 may be determined. In one configuration, the neighbor map may be efficiently implemented by vectorized/single instruction, multiple data (SIMD) instructions. Image processing and computer vision functions that involve border-following may take grayscale images 114 as input and convert them to binary images 114 (by setting all nonzero pixels to one, for instance). The neighbor map may be naturally merged into a binarization step of border-following algorithms with little overhead. Therefore, the complicated branches and/or loops of neighbor search during border-following may be replaced with a single LUT operation using the neighbor map mask bits 116 as an index. The neighbor map may also save bus bandwidth of accessing the neighbor pixels 118 during a neighbor search.

Border-following is a fundamental technique in the processing of digitized binary images. Border-following derives a sequence of the coordinates or the chain codes from the border between a connected component of 1-pixels (1-component) and a connected component of 0-pixels (background or hole). Border-following algorithms have been extensively studied, and have a wide variety of applications, such as picture recognition, topological analysis, object counting, and image compression.

When the term “neighborhood” 632 is mentioned in the algorithm described in FIG. 6, it means the 8-neighborhood in the 8-connected case: 1-pixels 116 as 8-connected and 0-pixels 116 as 4-connected. In this example, an input binary image 114 may be represented as F={f_{i,j}}. The image 114 may be scanned with raster scan order. The algorithm illustrated in Listing (2) may be performed for each pixel 116 where f_{i,j}≠0.

Listing (2)

| | |
|---|---|
| (1) | Select one of the following: |

| | (1.a) | If f_{i,j} = 1 and f_{i,j-i} = 0, then decide that the pixel (i, j) is the border- |
|---|---|---|
| | | following starting-point of an outer border, and (i₂, j₂) ← (i, j − 1). |
| | (1.b) | Else if f_{i,j} ≧ 1 and f_{i,j+1} = 0, then decide that the pixel (i, j) is the |
| | | border-following starting-point of a hole border, and (i₂, j₂) ← (i, j + 1). |
| | (1.c) | Otherwise, go to (3). |
| (2) | From the starting-point(i, j), follow the detected border by the following | |
| | substeps (2.1) through (2.5). | |
| | (2.1) | Starting from (i₂, j₂), look around clockwise at the pixels 116 in the |
| | | neighborhood of (i, j) and find a non-zero pixel 116. Let (i₁, j₁) be the |
| | | first found non-zero pixel 116. If no non-zero pixel 116 is found, assign - |
| | | 2 to f_{i,j} and go to (3). |
| | (2.2) | (i₂, j₂) ← (i₁, j₁) and (i₃, j₃) ← (i, j). |
| | (2.3) | Starting from the next element of the pixel (i₂, j₂) in the |
| | | counterclockwise order, examine counterclockwise the pixels 116 in the |
| | | neighborhood of the current pixel (i₃, j₃) to find a non-zero pixel 116 |
| | | and let the first one be (i₄, j₄). |
| | (2.4) | Change the value fᵢ_{₃}_{,j}_{₃} of the pixel (i₃, j₃) as follows: |

| | |
|---|---|
| (2.4a) | If the pixel (i₃, j₃ + 1) is a 0-pixel examined in the substep (2.3), |
| | then fᵢ_{₃}_{,j}_{₃} ← −2. |
| (2.4b) | If the pixel (i₃, j₃ + 1) is not a 0-pixel examined in the substep |
| | (2.3) and fᵢ_{₃}_{,j}_{₃} = 1 , then fᵢ_{₃}_{,j}_{₃} ← 2. |
| (2.4c) | Otherwise, do not change fᵢ_{₃}_{,j}_{₃} . |

| | |
|---|---|
| (2.5) | If (i₄, j₄) = (i, j) and (i₃, j₃) = (i₁, j₁) (coming back to the starting- |
| | point), then go to (3); otherwise, (i₂, j₂) ← (i₃, j₃), (i₃, j₃) ← (i₄, j₄), and |
| | go back to (2.3). |

| | |
|---|---|
| (3) | Resume the raster scan from the pixel (i, j + 1). The algorithm may terminate |
| | when the scan reaches the lower right corner of the image 114. |

The 8 neighbors of a 1-pixel may be indexed as illustrated in the neighbor pixel indexes 630 in FIG. 6. If (1.a) of Listing (2) is true, the clockwise search of the pixels 116 in the neighborhood 632 of (i,j) in (2.1) of Listing (2) may be implemented by the C code illustrated in Listing (3).

Listing (3)

// Search Algorithm 1
s = 4;
sEnd = s;
do {

s = (s−1)&0x07;
i1 = i0+neighbor3x3Offset[s];

} while (s!=sEnd && 0==*i1);

In Listing (3), s and sEnd are the indices of the neighbor pixels 116, i0 is the pointer to the border-following starting-point, i1 is the pointer to the neighbor pixels 116, and neighbor3×3Offset is the array of the address offsets of the 8 neighbor pixels 116.

If (1.b) of Listing (2) is true, the clockwise search of the pixels 116 in the neighborhood of (i,j) in (2.1) of Listing (2) may be implemented by the C code illustrated in Listing (4).

Listing (4)

// Search Algorithm 2
s = 0;
sEnd = s;
do {

s = (s−1)&0x07;
i1 = i0+neighbor3x3Offset[s];

} while (s!=sEnd && 0==*i1);

The difference with the previous C code (illustrated in Listing (3)) is the starting neighbor pixel 116 of the clockwise search. The counterclockwise search of the pixels 116 in the neighborhood of (i₃, j₃) in (2.3) of Listing (2) may be implemented by the C code illustrated in Listing (5).

Listing (5)

// Search Algorithm 3
do {

s = (s+1)&0x07;
i4= i3+neighbor3x3Offset[s];

} while (0 == *i4);

In Listing (5), s is the index of the neighbor pixels 116, i3 is the pointer to the current pixel, i4 is the pointer to the neighbor pixels 116, and neighbor3×3Offset is the array of the address offsets of the 8 neighbor pixels 116.

During these searches (as illustrated in Listings (3), (4) and (5)), part or all of the neighbor pixels 116 are read and compared with 0. Based on the comparison results, the mask bits 118 (e.g., the neighbor index) are updated and the next neighbor pixel 116 is then processed. These searches may be performed more efficiently by using a neighbor map. For each pixel 116 of a binary image 114, a neighbor map of 8 mask bits 118 may be defined where the i-th mask bit 118 is 1 if and only if the i-th neighbor pixel 116 is non-zero, and the i-th mask bit 118 is 0 if and only if the i-th neighbor pixel 118 is zero. FIG. 6 illustrates an example of a neighborhood 632. In this example, a non-zero neighbor pixel 116 is indicated by a shaded field and a zero neighbor pixel 116 is indicated by a white field. Starting from neighbor pixel index (0), the corresponding neighbor map of the neighborhood 632 is 0b11100111=0xE7.

An assistant image buffer, with the same size as the input binary image 114, may store the neighbor map of each pixel 116 of the input binary image 114. For example, a neighbor map of the pixel (i, j) may be denoted by n₁₁. The neighbor map of the 8 neighbor pixels 116 of the pixel (i,j) may be calculated as illustrated in listing (6).

Listing (6)

n_{i,j+1} | = f_{i,j} << 4
n_{i-1,j+1} | = f_{i,j} << 5
n_{i-1,j} | = f_{i,j} << 2
n_{i-1,j-1} | = f_{i,j} << 7
n_{i,j-1} | = f_{i,j} << 0
n_{i+1,j-1} | = f_{i,j} << 1
n_{i+1,j} | = f_{i,j} << 2
n_{i+1,j+1} | = f_{i,j} << 3

In one configuration, the operations illustrated in Listing (6) may be efficiently implemented using vectorized/SIMD instructions. The calculation of 8 bits of 8 neighbor maps (totaling 64 bits), may be implemented by the pseudo code illustrated in Listing (7).

Listing (7)

// R1:0 = n07|n06|n05|n04|n03|n02|n01|n00
// R3:2 = n17|n16|n15|n14|n13|n12|n11|n10
// R5:4 = n27|n26|n25|n24|n23|n22|n21|n20
// R7:6 = f17|f16|f15|f14|f13|f12|f11|f10

| | | |
|---|---|---|
| R9:8 = MEMD( ) | //[load f1f\|f1e\|f1d\|f1c\|f1b\|f1a\|f19\|f18 | ] |
| R11:10 = VALIGNB(R9:8,R7:6,#1) | //[f18\|f17\|f16\|f15\|f14\|f13\|f12\|f11 | ] |
| R1:0 \|= ASR(R11:10,#7) | //[n07\|n06\|n05\|n04\|n03\|n02\|n01\|n00 | ] |
| MEMD( ) = R1:0 | //[store n07\|n06\|n05\|n04\|n03\|n02\|n01\|n00 | ] |
| R3:2 \|= ASR(R11:10,#0) | //[n17\|n16\|n15\|n14\|n13\|n12\|n11\|n10 | ] |
| MEMD( ) = R3:2 | //[store n17\|n16\|n15\|n14\|n13\|n12\|n11\|n10 | ] |
| R5:4 \|=ASR(R11:10,#1) | //[n27\|n26\|n25\|n24\|n23\|n22\|n21\|n20 | ] |
| MEMD( ) = R5:4 | //[store n27\|n26\|n25\|n24\|n23\|n22\|n21\|n20 | ] |
| R1:0 = MEMD( ) | //[load n0f\|n0e\|n0d\|n0c\|n0b\|n0a\|n09\|n08 | ] |
| R3:2 = MEMD( ) | //[load n1f\|n1e\|n1d\|n1c\|n1b\|n1a\|n19\|n18 | ] |
| R1:0 \|= ASR(R9:8,#6) | //[n0f\|n0e\|n0d\|n0c\|n0b\|n0a\|n09\|n08 | ] |
| R5:4 = ASR(R9:8,#2) | //[n2f\|n2e\|n2d\|n2c\|n2b\|n2a\|n29\|n28 | ] |
| R11:10 = VALIGNB(R9:8,R7:6,#7) | //[f1e\|f1d\|f1c\|f1b\|f1a\|f19\|f18\|f17 | ] |
| R1:0 \|= ASR(R11:10,#5) | //[n0f\|n0e\|n0d\|n0c\|n0b\|n0a\|n09\|n08 | ] |
| R3:2 \|= ASR(R11:10,#4) | //[n1f\|n1e\|n1d\|n1c\|n1b\|n1a\|n19\|n18 | ] |
| R5:4 \|= ASR(R11:10,#3) | //[n2f\|n2e\|n2d\|n2c\|n2b\|n2a\|n29\|n28 | ] |

There are 10 vectorized/SIMD (XTYPE) instructions and 6 load/store (LD/ST) instructions for 8 neighbor maps, which may achieve 0.625 packet/pixel. For an 8-neighborhood 632, there is a total of 256 possible neighbor maps, as represented by different combinations of mask bits 118. In one configuration of a digital signal processor, one packet can be executed in a single cycle, which may contain at most 4 instructions. In each packet, there may be at most 2 XTYPE instructions, and at most 2 LD/ST instructions.

The search algorithm 1 described above may be accelerated by the 256 bit, one-dimensional lookup table startingPointOuterBorder[256] illustrated in Listing (8) using the neighbor map of the starting point as an index. The corresponding entry is the index of the searched pixel 116.

Listing (8)

startingPointOuterBorder[256] =
{

4, 0, 1, 1, 2, 2, 2, 2, 3, 3, 3, 3, 3, 3, 3, 3,
4, 0, 1, 1, 2, 2, 2, 2, 3, 3, 3, 3, 3, 3, 3, 3,
5, 0, 1, 1, 2, 2, 2, 2, 3, 3, 3, 3, 3, 3, 3, 3,
5, 0, 1, 1, 2, 2, 2, 2, 3, 3, 3, 3, 3, 3, 3, 3,
6, 0, 1, 1, 2, 2, 2, 2, 3, 3, 3, 3, 3, 3, 3, 3,
6, 0, 1, 1, 2, 2, 2, 2, 3, 3, 3, 3, 3, 3, 3, 3,
6, 0, 1, 1, 2, 2, 2, 2, 3, 3, 3, 3, 3, 3, 3, 3,
6, 0, 1, 1, 2, 2, 2, 2, 3, 3, 3, 3, 3, 3, 3, 3,
7, 0, 1, 1, 2, 2, 2, 2, 3, 3, 3, 3, 3, 3, 3, 3,
7, 0, 1, 1, 2, 2, 2, 2, 3, 3, 3, 3, 3, 3, 3, 3,
7, 0, 1, 1, 2, 2, 2, 2, 3, 3, 3, 3, 3, 3, 3, 3,
7, 0, 1, 1, 2, 2, 2, 2, 3, 3, 3, 3, 3, 3, 3, 3,
7, 0, 1, 1, 2, 2, 2, 2, 3, 3, 3, 3, 3, 3, 3, 3,
7, 0, 1, 1, 2, 2, 2, 2, 3, 3, 3, 3, 3, 3, 3, 3,
7, 0, 1, 1, 2, 2, 2, 2, 3, 3, 3, 3, 3, 3, 3, 3,
7, 0, 1, 1, 2, 2, 2, 2, 3, 3, 3, 3, 3, 3, 3, 3,

};

The search algorithm 2 described above may be accelerated by the 256 bit, one-dimensional lookup table startingPointHoleBorder[256] illustrated in Listing (9) using the neighbor map of the starting-point as an index. The corresponding entry is the index of the searched pixel.

Listing (9)

startingPointHoleBorder[256] =
{

0, 0, 1, 1, 2, 2, 2, 2, 3, 3, 3, 3, 3, 3, 3, 3,
4, 4, 4, 4, 4, 4, 4, 4, 4, 4, 4, 4, 4, 4, 4, 4,
5, 5, 5, 5, 5, 5, 5, 5, 5, 5, 5, 5, 5, 5, 5, 5,
5, 5, 5, 5, 5, 5, 5, 5, 5, 5, 5, 5, 5, 5, 5, 5,
6, 6, 6, 6, 6, 6, 6, 6, 6, 6, 6, 6, 6, 6, 6, 6,
6, 6, 6, 6, 6, 6, 6, 6, 6, 6, 6, 6, 6, 6, 6, 6,
6, 6, 6, 6, 6, 6, 6, 6, 6, 6, 6, 6, 6, 6, 6, 6,
6, 6, 6, 6, 6, 6, 6, 6, 6, 6, 6, 6, 6, 6, 6, 6,
7, 7, 7, 7, 7, 7, 7, 7, 7, 7, 7, 7, 7, 7, 7, 7,
7, 7, 7, 7, 7, 7, 7, 7, 7, 7, 7, 7, 7, 7, 7, 7,
7, 7, 7, 7, 7, 7, 7, 7, 7, 7, 7, 7, 7, 7, 7, 7,
7, 7, 7, 7, 7, 7, 7, 7, 7, 7, 7, 7, 7, 7, 7, 7,
7, 7, 7, 7, 7, 7, 7, 7, 7, 7, 7, 7, 7, 7, 7, 7,
7, 7, 7, 7, 7, 7, 7, 7, 7, 7, 7, 7, 7, 7, 7, 7,
7, 7, 7, 7, 7, 7, 7, 7, 7, 7, 7, 7, 7, 7, 7, 7,
7, 7, 7, 7, 7, 7, 7, 7, 7, 7, 7, 7, 7, 7, 7, 7,

};

The search algorithm 3 described above may be accelerated by the 256-by-8 bit 2-dimensional lookup table borderFollowing[256][8] illustrated in Listing (10) using the neighbor map of the current pixel 116 and the index of the previous pixel 116 in the current neighborhood 632 as indices, respectively. The corresponding entry is the index of the searched pixel 116.

Listing (10)

borderFollowing[256][8] =
{

{ 0, 0, 0, 0, 0, 0, 0, 0 }, { 0, 0, 0, 0, 0, 0, 0, 0 }, { 1, 1, 1, 1, 1, 1, 1, 1 },
{ 1, 0, 0, 0, 0, 0, 0, 0 }, { 2, 2, 2, 2, 2, 2, 2, 2 }, { 2, 2, 0, 0, 0, 0, 0, 0 },
{ 1, 2, 1, 1, 1, 1, 1, 1 }, { 1, 2, 0, 0, 0, 0, 0, 0 }, { 3, 3, 3, 3, 3, 3, 3, 3 },
{ 3, 3, 3, 0, 0, 0, 0, 0 }, { 1, 3, 3, 1, 1, 1, 1, 1 }, { 1, 3, 3, 0, 0, 0, 0, 0 },
{ 2, 2, 3, 2, 2, 2, 2, 2 }, { 2, 2, 3, 0, 0, 0, 0, 0 }, { 1, 2, 3, 1, 1, 1, 1, 1 },
{ 1, 2, 3, 0, 0, 0, 0, 0 }, { 4, 4, 4, 4, 4, 4, 4, 4 }, { 4, 4, 4, 4, 0, 0, 0, 0 },
{ 1, 4, 4, 4, 1, 1, 1, 1 }, { 1, 4, 4, 4, 0, 0, 0, 0 }, { 2, 2, 4, 4, 2, 2, 2, 2 },
{ 2, 2, 4, 4, 0, 0, 0, 0 }, { 1, 2, 4, 4, 1, 1, 1, 1 }, { 1, 2, 4, 4, 0, 0, 0, 0 },
{ 3, 3, 3, 4, 3, 3, 3, 3 }, { 3, 3, 3, 4, 0, 0, 0, 0 }, { 1, 3, 3, 4, 1, 1, 1, 1 },
{ 1, 3, 3, 4, 0, 0, 0, 0 }, { 2, 2, 3, 4, 2, 2, 2, 2 }, { 2, 2, 3, 4, 0, 0, 0, 0 },
{ 1, 2, 3, 4, 1, 1, 1, 1 }, { 1, 2, 3, 4, 0, 0, 0, 0 }, { 5, 5, 5, 5, 5, 5, 5, 5 },
{ 5, 5, 5, 5, 5, 0, 0, 0 }, { 1, 5, 5, 5, 5, 1, 1, 1 }, { 1, 5, 5, 5, 5, 0, 0, 0 },
{ 2, 2, 5, 5, 5, 2, 2, 2 }, { 2, 2, 5, 5, 5, 0, 0, 0 }, { 1, 2, 5, 5, 5, 1, 1, 1 },
{ 1, 2, 5, 5, 5, 0, 0, 0 }, { 3, 3, 3, 5, 5, 3, 3, 3 }, { 3, 3, 3, 5, 5, 0, 0, 0 },
{ 1, 3, 3, 5, 5, 1, 1, 1 }, { 1, 3, 3, 5, 5, 0, 0, 0 }, { 2, 2, 3, 5, 5, 2, 2, 2 },
{ 2, 2, 3, 5, 5, 0, 0, 0 }, { 1, 2, 3, 5, 5, 1, 1, 1 }, { 1, 2, 3, 5, 5, 0, 0, 0 },
{ 4, 4, 4, 4, 5, 4, 4, 4 }, { 4, 4, 4, 4, 5, 0, 0, 0 }, { 1, 4, 4, 4, 5, 1, 1, 1 },
{ 1, 4, 4, 4, 5, 0, 0, 0 }, { 2, 2, 4, 4, 5, 2, 2, 2 }, { 2, 2, 4, 4, 5, 0, 0, 0 },
{ 1, 2, 4, 4, 5, 1, 1, 1 }, { 1, 2, 4, 4, 5, 0, 0, 0 }, { 3, 3, 3, 4, 5, 3, 3, 3 },
{ 3, 3, 3, 4, 5, 0, 0, 0 }, { 1, 3, 3, 4, 5, 1, 1, 1 }, { 1, 3, 3, 4, 5, 0, 0, 0 },
{ 2, 2, 3, 4, 5, 2, 2, 2 }, { 2, 2, 3, 4, 5, 0, 0, 0 }, { 1, 2, 3, 4, 5, 1, 1, 1 },
{ 1, 2, 3, 4, 5, 0, 0, 0 }, { 6, 6, 6, 6, 6, 6, 6, 6 }, { 6, 6, 6, 6, 6, 6, 0, 0 },
{ 1, 6, 6, 6, 6, 6, 1, 1 }, { 1, 6, 6, 6, 6, 6, 0, 0 }, { 2, 2, 6, 6, 6, 6, 2, 2 },
{ 2, 2, 6, 6, 6, 6, 0, 0 }, { 1, 2, 6, 6, 6, 6, 1, 1 }, { 1, 2, 6, 6, 6, 6, 0, 0 },
{ 3, 3, 3, 6, 6, 6, 3, 3 }, { 3, 3, 3, 6, 6, 6, 0, 0 }, { 1, 3, 3, 6, 6, 6, 1, 1 },
{ 1, 3, 3, 6, 6, 6, 0, 0 }, { 2, 2, 3, 6, 6, 6, 2, 2 }, { 2, 2, 3, 6, 6, 6, 0, 0 },
{ 1, 2, 3, 6, 6, 6, 1, 1 }, { 1, 2, 3, 6, 6, 6, 0, 0 }, { 4, 4, 4, 4, 6, 6, 4, 4 },
{ 4, 4, 4, 4, 6, 6, 0, 0 }, { 1, 4, 4, 4, 6, 6, 1, 1 }, { 1, 4, 4, 4, 6, 6, 0, 0 },
{ 2, 2, 4, 4, 6, 6, 2, 2 }, { 2, 2, 4, 4, 6, 6, 0, 0 }, { 1, 2, 4, 4, 6, 6, 1, 1 },
{ 1, 2, 4, 4, 6, 6, 0, 0 }, { 3, 3, 3, 4, 6, 6, 3, 3 }, { 3, 3, 3, 4, 6, 6, 0, 0 },
{ 1, 3, 3, 4, 6, 6, 1, 1 }, { 1, 3, 3, 4, 6, 6, 0, 0 }, { 2, 2, 3, 4, 6, 6, 2, 2 },
{ 2, 2, 3, 4, 6, 6, 0, 0 }, { 1, 2, 3, 4, 6, 6, 1, 1 }, { 1, 2, 3, 4, 6, 6, 0, 0 },
{ 5, 5, 5, 5, 5, 6, 5, 5 }, { 5, 5, 5, 5, 5, 6, 0, 0 }, { 1, 5, 5, 5, 5, 6, 1, 1 },
{ 1, 5, 5, 5, 5, 6, 0, 0 }, { 2, 2, 5, 5, 5, 6, 2, 2 }, { 2, 2, 5, 5, 5, 6, 0, 0 },
{ 1, 2, 5, 5, 5, 6, 1, 1 }, { 1, 2, 5, 5, 5, 6, 0, 0 }, { 3, 3, 3, 5, 5, 6, 3, 3 },
{ 3, 3, 3, 5, 5, 6, 0, 0 }, { 1, 3, 3, 5, 5, 6, 1, 1 }, { 1, 3, 3, 5, 5, 6, 0, 0 },
{ 2, 2, 3, 5, 5, 6, 2, 2 }, { 2, 2, 3, 5, 5, 6, 0, 0 }, { 1, 2, 3, 5, 5, 6, 1, 1 },
{ 1, 2, 3, 5, 5, 6, 0, 0 }, { 4, 4, 4, 4, 5, 6, 4, 4 }, { 4, 4, 4, 4, 5, 6, 0, 0 },
{ 1, 4, 4, 4, 5, 6, 1, 1 }, { 1, 4, 4, 4, 5, 6, 0, 0 }, { 2, 2, 4, 4, 5, 6, 2, 2 },
{ 2, 2, 4, 4, 5, 6, 0, 0 }, { 1, 2, 4, 4, 5, 6, 1, 1 }, { 1, 2, 4, 4, 5, 6, 0, 0 },
{ 3, 3, 3, 4, 5, 6, 3, 3 }, { 3, 3, 3, 4, 5, 6, 0, 0 }, { 1, 3, 3, 4, 5, 6, 1, 1 },
{ 1, 3, 3, 4, 5, 6, 0, 0 }, { 2, 2, 3, 4, 5, 6, 2, 2 }, { 2, 2, 3, 4, 5, 6, 0, 0 },
{ 1, 2, 3, 4, 5, 6, 1, 1 }, { 1, 2, 3, 4, 5, 6, 0, 0 }, { 7, 7, 7, 7, 7, 7, 7, 7 },
{ 7, 7, 7, 7, 7, 7, 7, 0 }, { 1, 7, 7, 7, 7, 7, 7, 1 }, { 1, 7, 7, 7, 7, 7, 7, 0 },
{ 2, 2, 7, 7, 7, 7, 7, 2 }, { 2, 2, 7, 7, 7, 7, 7, 0 }, { 1, 2, 7, 7, 7, 7, 7, 1 },
{ 1, 2, 7, 7, 7, 7, 7, 0 }, { 3, 3, 3, 7, 7, 7, 7, 3 }, { 3, 3, 3, 7, 7, 7, 7, 0 },
{ 1, 3, 3, 7, 7, 7, 7, 1 }, { 1, 3, 3, 7, 7, 7, 7, 0 }, { 2, 2, 3, 7, 7, 7, 7, 2 },
{ 2, 2, 3, 7, 7, 7, 7, 0 }, { 1, 2, 3, 7, 7, 7, 7, 1 }, { 1, 2, 3, 7, 7, 7, 7, 0 },
{ 4, 4, 4, 4, 7, 7, 7, 4 }, { 4, 4, 4, 4, 7, 7, 7, 0 }, { 1, 4, 4, 4, 7, 7, 7, 1 },
{ 1, 4, 4, 4, 7, 7, 7, 0 }, { 2, 2, 4, 4, 7, 7, 7, 2 }, { 2, 2, 4, 4, 7, 7, 7, 0 },
{ 1, 2, 4, 4, 7, 7, 7, 1 }, { 1, 2, 4, 4, 7, 7, 7, 0 }, { 3, 3, 3, 4, 7, 7, 7, 3 },
{ 3, 3, 3, 4, 7, 7, 7, 0 }, { 1, 3, 3, 4, 7, 7, 7, 1 }, { 1, 3, 3, 4, 7, 7, 7, 0 },
{ 2, 2, 3, 4, 7, 7, 7, 2 }, { 2, 2, 3, 4, 7, 7, 7, 0 }, { 1, 2, 3, 4, 7, 7, 7, 1 },
{ 1, 2, 3, 4, 7, 7, 7, 0 }, { 5, 5, 5, 5, 5, 7, 7, 5 }, { 5, 5, 5, 5, 5, 7, 7, 0 },
{ 1, 5, 5, 5, 5, 7, 7, 1 }, { 1, 5, 5, 5, 5, 7, 7, 0 }, { 2, 2, 5, 5, 5, 7, 7, 2 },
{ 2, 2, 5, 5, 5, 7, 7, 0 }, { 1, 2, 5, 5, 5, 7, 7, 1 }, { 1, 2, 5, 5, 5, 7, 7, 0 },
{ 3, 3, 3, 5, 5, 7, 7, 3 }, { 3, 3, 3, 5, 5, 7, 7, 0 }, { 1, 3, 3, 5, 5, 7, 7, 1 },
{ 1, 3, 3, 5, 5, 7, 7, 0 }, { 2, 2, 3, 5, 5, 7, 7, 2 }, { 2, 2, 3, 5, 5, 7, 7, 0 },
{ 1, 2, 3, 5, 5, 7, 7, 1 }, { 1, 2, 3, 5, 5, 7, 7, 0 }, { 4, 4, 4, 4, 5, 7, 7, 4 },
{ 4, 4, 4, 4, 5, 7, 7, 0 }, { 1, 4, 4, 4, 5, 7, 7, 1 }, { 1, 4, 4, 4, 5, 7, 7, 0 },
{ 2, 2, 4, 4, 5, 7, 7, 2 }, { 2, 2, 4, 4, 5, 7, 7, 0 }, { 1, 2, 4, 4, 5, 7, 7, 1 },
{ 1, 2, 4, 4, 5, 7, 7, 0 }, { 3, 3, 3, 4, 5, 7, 7, 3 }, { 3, 3, 3, 4, 5, 7, 7, 0 },
{ 1, 3, 3, 4, 5, 7, 7, 1 }, { 1, 3, 3, 4, 5, 7, 7, 0 }, { 2, 2, 3, 4, 5, 7, 7, 2 },
{ 2, 2, 3, 4, 5, 7, 7, 0 }, { 1, 2, 3, 4, 5, 7, 7, 1 }, { 1, 2, 3, 4, 5, 7, 7, 0 },
{ 6, 6, 6, 6, 6, 6, 7, 6 }, { 6, 6, 6, 6, 6, 6, 7, 0 }, { 1, 6, 6, 6, 6, 6, 7, 1 },
{ 1, 6, 6, 6, 6, 6, 7, 0 }, { 2, 2, 6, 6, 6, 6, 7, 2 }, { 2, 2, 6, 6, 6, 6, 7, 0 },
{ 1, 2, 6, 6, 6, 6, 7, 1 }, { 1, 2, 6, 6, 6, 6, 7, 0 }, { 3, 3, 3, 6, 6, 6, 7, 3 },
{ 3, 3, 3, 6, 6, 6, 7, 0 }, { 1, 3, 3, 6, 6, 6, 7, 1 }, { 1, 3, 3, 6, 6, 6, 7, 0 },
{ 2, 2, 3, 6, 6, 6, 7, 2 }, { 2, 2, 3, 6, 6, 6, 7, 0 }, { 1, 2, 3, 6, 6, 6, 7, 1 },
{ 1, 2, 3, 6, 6, 6, 7, 0 }, { 4, 4, 4, 4, 6, 6, 7, 4 }, { 4, 4, 4, 4, 6, 6, 7, 0 },
{ 1, 4, 4, 4, 6, 6, 7, 1 }, { 1, 4, 4, 4, 6, 6, 7, 0 }, { 2, 2, 4, 4, 6, 6, 7, 2 },
{ 2, 2, 4, 4, 6, 6, 7, 0 }, { 1, 2, 4, 4, 6, 6, 7, 1 }, { 1, 2, 4, 4, 6, 6, 7, 0 },
{ 3, 3, 3, 4, 6, 6, 7, 3 }, { 3, 3, 3, 4, 6, 6, 7, 0 }, { 1, 3, 3, 4, 6, 6, 7, 1 },
{ 1, 3, 3, 4, 6, 6, 7, 0 }, { 2, 2, 3, 4, 6, 6, 7, 2 }, { 2, 2, 3, 4, 6, 6, 7, 0 },
{ 1, 2, 3, 4, 6, 6, 7, 1 }, { 1, 2, 3, 4, 6, 6, 7, 0 }, { 5, 5, 5, 5, 5, 6, 7, 5 },
{ 5, 5, 5, 5, 5, 6, 7, 0 }, { 1, 5, 5, 5, 5, 6, 7, 1 }, { 1, 5, 5, 5, 5, 6, 7, 0 },
{ 2, 2, 5, 5, 5, 6, 7, 2 }, { 2, 2, 5, 5, 5, 6, 7, 0 }, { 1, 2, 5, 5, 5, 6, 7, 1 },
{ 1, 2, 5, 5, 5, 6, 7, 0 }, { 3, 3, 3, 5, 5, 6, 7, 3 }, { 3, 3, 3, 5, 5, 6, 7, 0 },
{ 1, 3, 3, 5, 5, 6, 7, 1 }, { 1, 3, 3, 5, 5, 6, 7, 0 }, { 2, 2, 3, 5, 5, 6, 7, 2 },
{ 2, 2, 3, 5, 5, 6, 7, 0 }, { 1, 2, 3, 5, 5, 6, 7, 1 }, { 1, 2, 3, 5, 5, 6, 7, 0 },
{ 4, 4, 4, 4, 5, 6, 7, 4 }, { 4, 4, 4, 4, 5, 6, 7, 0 }, { 1, 4, 4, 4, 5, 6, 7, 1 },
{ 1, 4, 4, 4, 5, 6, 7, 0 }, { 2, 2, 4, 4, 5, 6, 7, 2 }, { 2, 2, 4, 4, 5, 6, 7, 0 },
{ 1, 2, 4, 4, 5, 6, 7, 1 }, { 1, 2, 4, 4, 5, 6, 7, 0 }, { 3, 3, 3, 4, 5, 6, 7, 3 },
{ 3, 3, 3, 4, 5, 6, 7, 0 }, { 1, 3, 3, 4, 5, 6, 7, 1 }, { 1, 3, 3, 4, 5, 6, 7, 0 },
{ 2, 2, 3, 4, 5, 6, 7, 2 }, { 2, 2, 3, 4, 5, 6, 7, 0 }, { 1, 2, 3, 4, 5, 6, 7, 1 },
{ 1, 2, 3, 4, 5, 6, 7, 0 },

};

Using the mask bits 118 of the neighbor map as an index of a lookup table (LUT) 122, the search algorithms may be accomplished by one single LUT 122 operation. This may reduce the otherwise unpredictable complexity of the search algorithms.

Utilizing a neighbor map, the neighbor search, whose complexity is linear and depends on the neighborhood 632, becomes a single LUT 122 operation with constant complexity. The sizes of the LUTs may be 256 bytes, 256 bytes and 2048 bytes, respectively. These LUTs may be readily held in cache and may cause little penalty for bus traffic. The systems and methods described in FIG. 6 may also be applied to the 4-connected case: 1-pixels as 4-connected and 0-pixels as 8-connected with different LUTs of smaller size (e.g., 16 bytes, 16 bytes and 64 bytes).

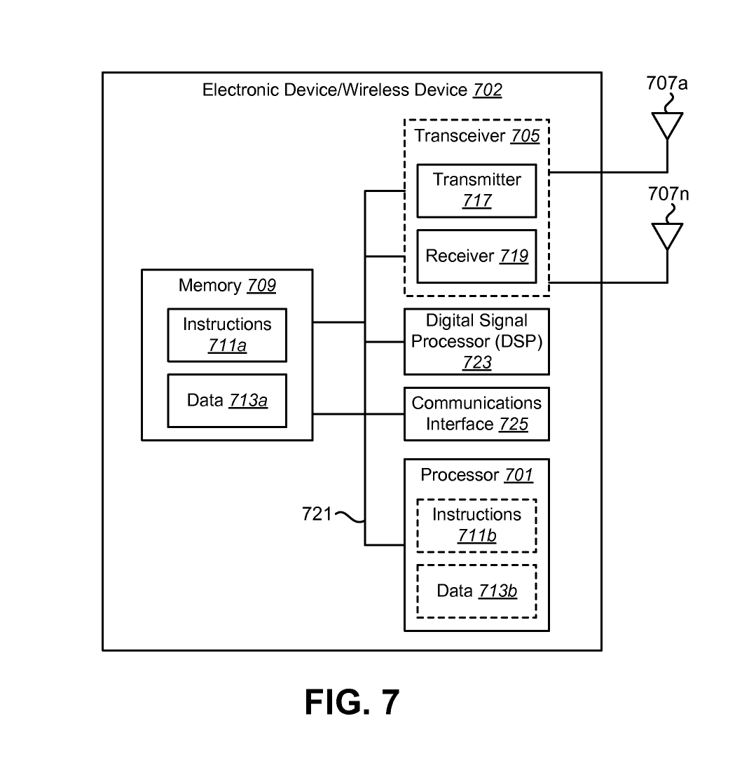

FIG. 7 illustrates certain components that may be included within an electronic device/wireless device 702. The electronic device/wireless device 702 may be implemented in accordance with the electronic device 102 described above. The electronic device/wireless device 702 may be an access terminal, a mobile station, a user equipment, etc. The electronic device/wireless device 702 includes a processor 701. The processor 701 may be a general purpose single- or multi-chip microprocessor (e.g., an ARM), a special purpose microprocessor (e.g., a digital signal processor (DSP)), a microcontroller, a programmable gate array, etc. The processor 701 may be referred to as a central processing unit (CPU). Although just a single processor 701 is shown in the electronic device/wireless device 702 of FIG. 7, in an alternative configuration, a combination of processors (e.g., an ARM and DSP) could be used.

The electronic device/wireless device 702 also includes memory 709. The memory 709 may be any electronic component capable of storing electronic information. The memory 709 may be embodied as random access memory (RAM), read-only memory (ROM), magnetic disk storage media, optical storage media, flash memory devices in RAM, on-board memory included with the processor, erasable programmable read-only memory (EPROM), electrically erasable PROM (EEPROM), registers and so forth, including combinations thereof.

Data 713a and instructions 711a may be stored in the memory 709. The instructions 711a may be executable by the processor 701 to implement the methods disclosed herein. Executing the instructions 711a may involve the use of the data 713a that is stored in the memory 709. When the processor 701 executes the instructions 711a, various portions of the instructions 711b may be loaded onto the processor 701, and various pieces of data 713b may be loaded onto the processor 701.

The electronic device/wireless device 702 may also include a transmitter 717 and a receiver 719 to allow transmission and reception of signals to and from the electronic device/wireless device 702. The transmitter 717 and receiver 719 may be collectively referred to as a transceiver 705. Multiple antennas 707a-n may be electrically coupled to the transceiver 705. The electronic device/wireless device 702 may also include (not shown) multiple transmitters, multiple receivers, multiple transceivers and/or additional antennas.

The electronic device/wireless device 702 may include a digital signal processor (DSP) 723. The electronic device/wireless device 702 may also include a communications interface 725. The communications interface 725 may allow a user to interact with the electronic device/wireless device 702.

The various components of the electronic device/wireless device 702 may be coupled together by one or more buses, which may include a power bus, a control signal bus, a status signal bus, a data bus, etc. For the sake of clarity, the various buses are illustrated in FIG. 7 as a bus system 721.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In accordance with the present disclosure, a circuit in a mobile device may be adapted to determine mask bits that indicate intensity comparisons between the current pixel and multiple neighbor pixels. The same circuit, a different circuit, or a second section of the same or different circuit may be adapted to determine mask bits that indicate whether each of the current pixel's neighbor pixels have been processed. The second section may advantageously be coupled to the first section, or it may be embodied in the same circuit as the first section. In addition, the same circuit, a different circuit, or a third section of the same or different circuit may be adapted to select a next pixel for processing based on the mask bits. The third section may advantageously be coupled to the first and second sections, or it may be embodied in the same circuit as the first and second sections.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 3, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for processing an image, comprising:
determining, for a current pixel, mask bits that indicate intensity comparisons between the current pixel and multiple neighbor pixels, wherein the mask bits also indicate whether each of the current pixel's neighbor pixels have been processed; and
selecting a next pixel for processing based on the mask bits.

2. The method of claim 1, wherein the selecting comprises accessing data in a lookup table using the mask bits as an index in the lookup table.

3. The method of claim 2, wherein the selecting further comprises selecting a next pixel based on whether any of the current pixel's neighbor pixels are both unprocessed and lower intensity than the current pixel.

4. The method of claim 1, wherein the mask bits comprise a comparison bit and a processing bit for each neighbor pixel.

5. The method of claim 1, wherein the neighbor pixels are orthogonally adjacent to the current pixel.

6. The method of claim 1, wherein the neighbor pixels are diagonally adjacent to the current pixel.

7. The method of claim 1, wherein the neighbor pixels are diagonally adjacent or orthogonally adjacent to the current pixel.

8. The method of claim 1, further comprising classifying, as part of an extremal region, the current pixel when it has no neighbor pixels that are unprocessed.

9. The method of claim 1, further comprising classifying the current pixel as part of a contour.

10. The method of claim 1, further comprising pre-processing each pixel in the image by performing the intensity comparison between a pixel and each of its neighbor pixels.

11. The method of claim 1, wherein the image is a frame in a video, wherein the method is performed for every frame in the video.

12. An apparatus for processing an image, comprising:
means for determining, for a current pixel, mask bits that indicate intensity comparisons between the current pixel and multiple neighbor pixels, wherein the mask bits also indicate whether each of the current pixel's neighbor pixels have been processed; and
means for selecting a next pixel for processing based on the mask bits.

13. The apparatus of claim 12, wherein the means for selecting comprise means for accessing data in a lookup table using the mask bits as an index in the lookup table.

14. The apparatus of claim 13, wherein the means for selecting further comprise means for selecting a next pixel based on whether any of the current pixel's neighbor pixels are both unprocessed and lower intensity than the current pixel.

15. The apparatus of claim 12, wherein the mask bits comprise a comparison bit and a processing bit for each neighbor pixel.

16. The apparatus of claim 12, wherein the neighbor pixels are orthogonally adjacent to the current pixel.

17. The apparatus of claim 12, wherein the neighbor pixels are diagonally adjacent to the current pixel.

18. The apparatus of claim 12, wherein the neighbor pixels are diagonally adjacent or orthogonally adjacent to the current pixel.

19. The apparatus of claim 12, further comprising means for classifying, as part of an extremal region, the current pixel when it has no neighbor pixels that are unprocessed.

20. The apparatus of claim 12, further comprising means for classifying the current pixel as part of a contour.

21. The apparatus of claim 12, further comprising means for pre-processing each pixel in the image by performing the intensity comparison between a pixel and each of its neighbor pixels.

22. The apparatus of claim 12, wherein the image is a frame in a video, wherein the apparatus processes every frame in the video.

23. An electronic device for processing an image, comprising:
a processor;
memory in electronic communication with the processor;
instructions stored in memory, the instructions being executable to:
determine, for a current pixel, mask bits that indicate intensity comparisons between the current pixel and multiple neighbor pixels, wherein the mask bits also indicate whether each of the current pixel's neighbor pixels have been processed; and
select a next pixel for processing based on the mask bits.

24. The electronic device of claim 23, wherein the instructions being executable to select comprise instructions being executable to access data in a lookup table using the mask bits as an index in the lookup table.

25. The electronic device of claim 24, wherein the instructions being executable to select further comprise instructions being executable to select a next pixel based on whether any of the current pixel's neighbor pixels are both unprocessed and lower intensity than the current pixel.

26. The electronic device of claim 23, wherein the mask bits comprise a comparison bit and a processing bit for each neighbor pixel.

27. The electronic device of claim 23, wherein the neighbor pixels are orthogonally adjacent to the current pixel.

28. The electronic device of claim 23, wherein the neighbor pixels are diagonally adjacent to the current pixel.

29. The electronic device of claim 23, wherein the neighbor pixels are diagonally adjacent or orthogonally adjacent to the current pixel.

30. The electronic device of claim 23, further comprising instructions being executable to classify, as part of an extremal region, the current pixel when it has no neighbor pixels that are unprocessed.

31. The electronic device of claim 23, further comprising instructions being executable to classify the current pixel as part of a contour.

32. The electronic device of claim 23, further comprising instructions being executable to pre-process each pixel in the image by performing the intensity comparison between a pixel and each of its neighbor pixels.

33. The electronic device of claim 23, wherein the image is a frame in a video, wherein the electronic device processes every frame in the video.

34. A computer-program product for processing an image, comprising a non-transitory computer-readable medium having instructions thereon, the instructions comprising:
code for causing an electronic device to determine, for a current pixel, mask bits that indicate intensity comparisons between the current pixel and multiple neighbor pixels, wherein the mask bits also indicate whether each of the current pixel's neighbor pixels have been processed; and
code for causing the electronic device to select a next pixel for processing based on the mask bits.

35. The computer-program product of claim 34, wherein the code for causing the electronic device to select comprises code for causing the electronic device to access data in a lookup table using the mask bits as an index in the lookup table.

36. The computer-program product of claim 35, wherein the code for causing the electronic device to select further comprises code for causing the electronic device to select a next pixel based on whether any of the current pixel's neighbor pixels are both unprocessed and lower intensity than the current pixel.

37. The computer-program product of claim 34, wherein the mask bits comprise a comparison bit and a processing bit for each neighbor pixel.

38. The computer-program product of claim 34, wherein the neighbor pixels are orthogonally adjacent to the current pixel.

39. The computer-program product of claim 34, wherein the neighbor pixels are diagonally adjacent to the current pixel.

40. The computer-program product of claim 34, wherein the neighbor pixels are diagonally adjacent or orthogonally adjacent to the current pixel.

41. The computer-program product of claim 34, further comprising code for causing the electronic device to classify, as part of an extremal region, the current pixel when it has no neighbor pixels that are unprocessed.

42. The computer-program product of claim 34, further comprising code for causing the electronic device to classify the current pixel as part of a contour.

43. The computer-program product of claim 34, further comprising code for causing the electronic device to pre-process each pixel in the image by performing the intensity comparison between a pixel and each of its neighbor pixels.

44. The computer-program product of claim 34, wherein the image is a frame in a video, wherein the electronic device processes every frame in the video.
